(19) United States
(12) Patent Application Publication
(10) Pub. No.: US 2023/0325850 A1
(43) Pub. Date: Oct. 12, 2023

(54) FAST IDENTITY ONLINE (FIDO) DEVICE ONBOARDING (FDO) PROTOCOL COMPUTING DEVICE ORDERING/MANUFACTURING SYSTEM

(71) Applicant: Dell Products L.P., Round Rock, TX (US)

(72) Inventors: Muzhar S. Khokhar, Shrewsbury, MA (US); Anurag Sharma, Cedar Park, TX (US); Daniel E. Cummins, Hudson, NH (US)

(21) Appl. No.: 17/717,496

(22) Filed: Apr. 11, 2022

(51) Int. Cl. G06Q 30/00; H04L 9/30

(52) U.S. Cl. CPC G06Q 30/0185; H04L 9/30

(57) ABSTRACT

A FDO protocol computing device ordering/manufacturing system includes a computing device manufacturer system coupled to a voucher management system. The computing device manufacturer system identifies, as part of an ordering process for a computing device being ordered by a subsequent owner, rendezvous system reachability information for a rendezvous system. The computing device manufacturer system provides the rendezvous system reachability information in the computing device prior to its transfer to the subsequent owner. The computing device provisioning subsystem retrieves a voucher management system public key from the voucher management system, uses a computing device manufacturer private key to sign the voucher management system public key to generate first ownership transfer data, provides the first ownership transfer data in an ownership voucher in order to transfer ownership of the computing device from the computing device manufacturer system to the voucher management system, and provides the ownership voucher to the voucher management system.

### BACKGROUND

The present disclosure relates generally to information handling systems, and more particularly to providing for the ordering and manufacturing of information handling systems utilizing Fast IDentity Online (FIDO) Device Onboarding (FDO) protocols.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The Fast IDentity Online (FIDO) Alliance has promulgated a set of security-focused technologies and protocols (“FIDO protocols” below) intended to simplify and enhance cybersecurity. Information handling systems such as, for example, server devices and/or other computing devices known in the art, may benefit by performing authentication via the FIDO Device Onboarding (FDO) protocol, particularly when provided at the “edge” of a network (“edge computing devices”). For example a computing device manufacturer may manufacture the edge computing device using the FIDFDO Device Initialization (DI) (FDO-DI) protocol, which provides for the generation of a public/private key pair, secure storage of the private key in the edge computing device, and inclusion of the public key in a digital ownership voucher that defines an “owner” of the edge computing device, with that digital ownership voucher configured to be transferred to using public/private key signing techniques to different “owners” of the edge computing device as it moves through the supply chain (e.g., Value-Added Resellers (VARs) and/or other resellers known the art) to an end user that provides the “last owner” of the edge computing device. However, the use of such digital ownership vouchers raises some issues.

To provide a specific example of the transfer of “ownership” of an edge computing device from a computing device manufacturer to a reseller via the FDO protocol, the computing device manufacturer will use its computing device manufacturer private key to sign a combination of edge computing device information and a reseller public key to produce first signed ownership transfer data, provide that first signed ownership transfer data in the digital ownership voucher to indicate that the reseller is the “owner” of the edge computing device, and transfer the digital ownership voucher to the reseller. The reseller may then transfer “ownership” of the edge computing device to the end user by using its reseller private key to sign a combination of edge computing device information and an end user public key to produce second signed ownership transfer data, provide that second signed ownership transfer data in the digital ownership voucher along with the first signed ownership data to indicate that the end user is the “owner” of the edge computing device, and transfer the digital ownership voucher to the end user.

As such, the FDO protocol discussed above may require “owners” of the edge computing device to store digital ownership vouchers, generate and maintain respective public/private key pairs, retrieve the public key from any new owner, combine the edge computing device information and that public key and sign it with their private key to produce signed ownership transfer data, provide signed ownership transfer data in digital ownership vouchers, and/or transfer digital ownership vouchers to new owners. As such, implementation of the FDO protocol as discussed above will require digital infrastructure transformations across the supply chain, as well as the coordination, collaboration, and education of computing device manufacturers, resellers, and end users, which will operate to slow down the adoption of the FDO protocol.

Accordingly, it would be desirable to provide a FIDO Device Onboarding (FDO) protocol computing device ordering/manufacturing system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a computing device manufacturing engine that is configured to: identify, as part of an ordering process for a computing device being ordered by a subsequent owner, rendezvous system reachability information for at least one rendezvous system; provide the rendezvous system reachability information in the computing device prior to the computing device being transferred to the subsequent owner; retrieve, from a voucher management system, a voucher management system public key; sign, using a computing device manufacturer private key, the voucher management system public key to generate first ownership transfer data; provide the first ownership transfer data in an ownership voucher in order to transfer ownership of the computing device from the computing device manufacturer system to the voucher management system; and provide the ownership voucher to the voucher management system.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system that may include the FDO protocol ownership voucher management system of the present disclosure.

FIG. 3 is a schematic view illustrating an embodiment of a computing device manufacturer system that may be included in the networked system of FIG. 2.

FIG. 4 is a schematic view illustrating an embodiment of a voucher management system that may be included in the networked system of FIG. 2 and that may provide the FDO protocol ownership voucher management system of the present disclosure.

FIG. 5A is a flow chart illustrating an embodiment of a portion of a method for managing ownership vouchers.

FIG. 5B is a flow chart illustrating an embodiment of a portion of the method for managing ownership vouchers of FIG. 5A.

FIG. 6A is a schematic view illustrating an embodiment of the networked system of FIG. 2 operating during the method of FIG. 5.

FIG. 6B is a schematic view illustrating an embodiment of the computing device manufacturer system of FIG. 3 operating during the method of FIG. 5.

FIG. 7A is a schematic view illustrating an embodiment of an ownership voucher that may be generated during the method of FIG. 5.

FIG. 7B is a schematic view illustrating an embodiment of the computing device manufacturer system of FIG. 3 operating during the method of FIG. 5.

FIG. 7C is a schematic view illustrating an embodiment of the networked system of FIG. 2 operating during the method of FIG. 5.

FIG. 7D is a schematic view illustrating an embodiment of the voucher management system of FIG. 4 operating during the method of FIG. 5.

FIG. 8A is a schematic view illustrating an embodiment of the networked system of FIG. 2 operating during the method of FIG. 5.

FIG. 8B is a schematic view illustrating an embodiment of the computing device manufacturer system of FIG. 3 operating during the method of FIG. 5.

FIG. 8C is a schematic view illustrating an embodiment of the voucher management system of FIG. 4 operating during the method of FIG. 5.

FIG. 9A is a schematic view illustrating an embodiment of the computing device manufacturer system of FIG. 3 operating during the method of FIG. 5.

FIG. 9B is a schematic view illustrating an embodiment of the networked system of FIG. 2 operating during the method of FIG. 5.

FIG. 10A is a schematic view illustrating an embodiment of the networked system of FIG. 2 operating during the method of FIG. 5.

FIG. 10B is a schematic view illustrating an embodiment of the voucher management system of FIG. 4 operating during the method of FIG. 5.

FIG. 10C is a schematic view illustrating an embodiment of the networked system of FIG. 2 operating during the method of FIG. 5.

FIG. 10D is a schematic view illustrating an embodiment of the computing device manufacturer system of FIG. 3 operating during the method of FIG. 5.

FIG. 10E is a schematic view illustrating an embodiment of the voucher management system of FIG. 4 operating during the method of FIG. 5.

FIG. 10F is a schematic view illustrating an embodiment of the voucher management system of FIG. 4 operating during the method of FIG. 5.

FIG. 10G is a schematic view illustrating an embodiment of the networked system of FIG. 2 operating during the method of FIG. 5.

FIG. 11A is a schematic view illustrating an embodiment of the voucher management system of FIG. 4 operating during the method of FIG. 5.

FIG. 11B is a schematic view illustrating an embodiment of the ownership voucher of FIG. 7A that may have been modified during the method of FIG. 5.

FIG. 12A is a schematic view illustrating an embodiment of the voucher management system of FIG. 4 operating during the method of FIG. 5.

FIG. 12B is a schematic view illustrating an embodiment of the networked system of FIG. 2 operating during the method of FIG. 5.

FIG. 12C is a schematic view illustrating an embodiment of the networked system of FIG. 2 operating during the method of FIG. 5.

FIG. 13 is a schematic view illustrating an embodiment of the networked system of FIG. 2 operating during the method of FIG. 5.

FIG. 14 is a schematic view illustrating an embodiment of the networked system of FIG. 2 operating during the method of FIG. 5.

FIG. 15 is a schematic view illustrating an embodiment of the networked system of FIG. 2 operating during the method of FIG. 5.

FIG. 16 is a schematic view illustrating an embodiment of the networked system of FIG. 2 operating during the method of FIG. 5.

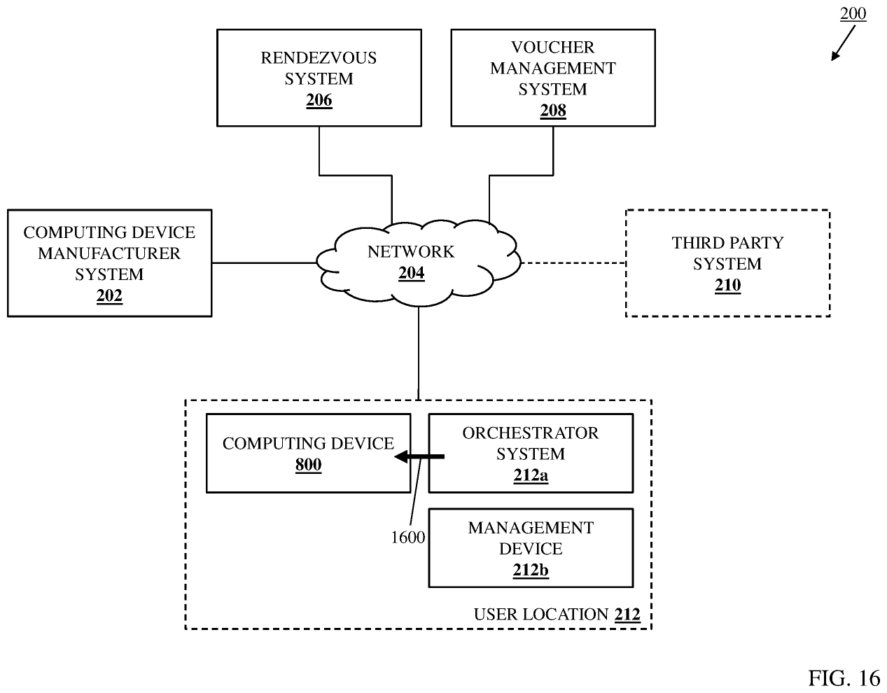

FIG. 17A is a schematic view illustrating an embodiment of the computing device manufacturer system of FIG. 3 operating during the method of FIG. 5.

FIG. 17B is a schematic view illustrating an embodiment of the networked system of FIG. 2 operating during the method of FIG. 5.

FIG. 18A is a schematic view illustrating an embodiment of the voucher management system of FIG. 4 operating during the method of FIG. 5.

FIG. 18B is a schematic view illustrating an embodiment of the ownership voucher of FIG. 7A that may have been modified during the method of FIG. 5.

FIG. 19 is a schematic view illustrating an embodiment of the ownership voucher of FIG. 7A that may have been modified during the method of FIG. 5.

FIG. 20 is a schematic view illustrating an embodiment of the networked system of FIG. 2 operating during the method of FIG. 5.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

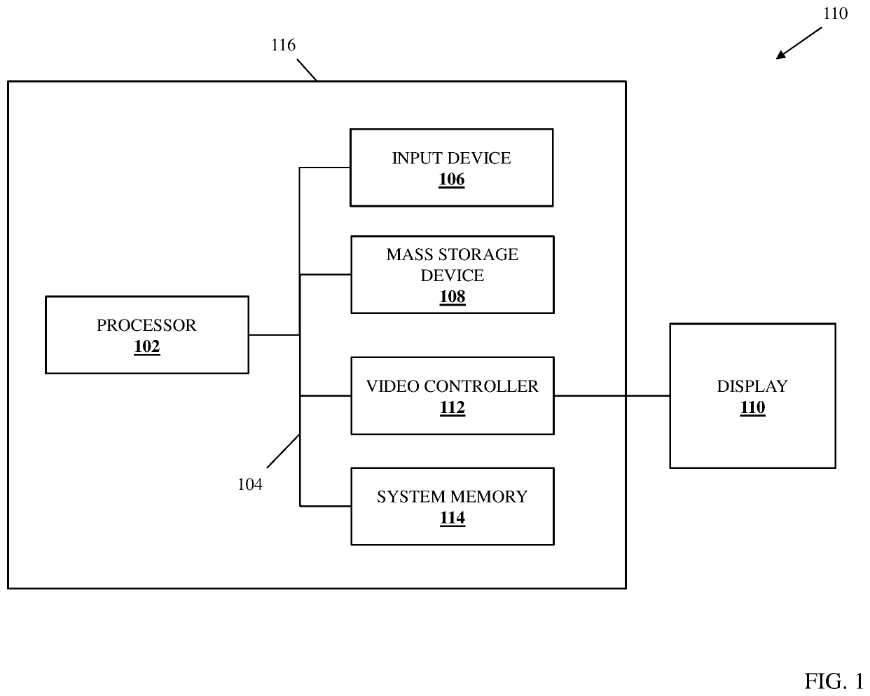

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

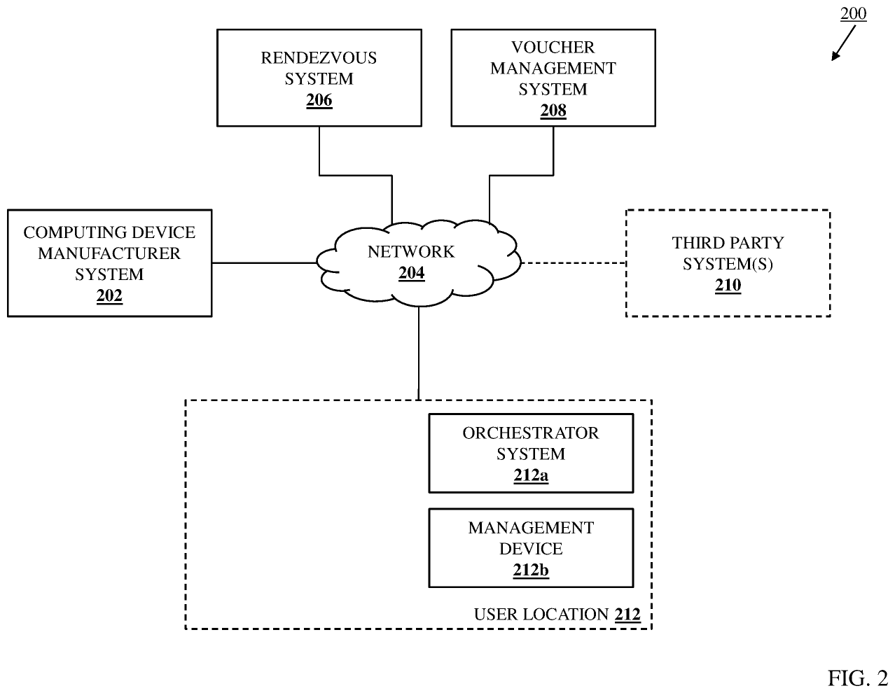

Referring now to FIG. 2, an embodiment of a networked system 200 is illustrated that may include the FDO protocol ownership voucher management system of the present disclosure. In the illustrated embodiment, the networked system 200 includes a computing device manufacturer system 202. In a specific example, the computing device manufacturer system 202 may be provided by DELL® Inc. of Round Rock, Texas, United States, although computing device manufacturing systems provided by other computing device manufacturers will fall within the scope of the present disclosure as well. In an embodiment, the computing device manufacturer system 202 may include one or more of the IHS 100 discussed above with reference to FIG. 1, and is discussed below as including a variety of computing device manufacturer subsystems that allow for the manufacture and provisioning of computing devices to end users and/or third parties (e.g., the resellers discussed herein). However, while illustrated and discussed as being provide by particular subsystems and devices, one of skill in the art in possession of the present disclosure will recognize that computing device manufacturer system 202 provided in the networked system 200 may include any subsystems and/or devices that may be configured to operate similarly as the computing device manufacturer system 202 discussed below. In the illustrated embodiment, the computing device manufacturing system 202 includes one or more devices coupled to a network 204 that may be provided by a Local Area Network (LAN), the Internet, combinations thereof, and/or any of a variety of other networks that would be apparent to one of skill in the art in possession of the present disclosure.

In the illustrated embodiment, the networked system 200 also includes a rendezvous system 206 that is coupled to the network 204. In an embodiment, the rendezvous system 206 may be provided by the IHS 100 discussed above with reference to FIG. 1 and/or may include some or all of the components of the IHS 100, and in the specific examples below is described as being provided by one or more server devices. However, while illustrated and discussed as being provided by server device(s), one of skill in the art in possession of the present disclosure will recognize that the functionality of the rendezvous system 206 discussed below may be provided by other devices that are configured to operate similarly as the rendezvous system 206 discussed below. The networked system 200 also includes a voucher management system 208 that is coupled to the network 204. In an embodiment, the voucher management system 208 may be provided by the IHS 100 discussed above with reference to FIG. 1 and/or may include some or all of the components of the IHS 100, and in the specific examples below is described as being provided by one or more server devices. However, while illustrated and discussed as being provided by server device(s), one of skill in the art in possession of the present disclosure will recognize that the functionality of the voucher management system 208 discussed below may be provided by other devices that are configured to operate similarly as the voucher management system 208 discussed below.

The embodiment illustrated in FIG. 2 illustrates how one or more third-party systems 210 may optionally be coupled to the network 204 (as indicated by the dashed lines used for the third-party system(s) 210). In specific examples, any of the third-party subsystem(s) 210 may be provided by Value-Added Resellers (VARs) and/or other resellers known in the art. In an embodiment, any of the third-party subsystem(s) 210 may include one or more of the IHS 100 discussed above with reference to FIG. 1, and are discussed below and including a variety of third party subsystems that allow for the reselling of computing devices manufactured by the computing device manufacturer system 202 to an end user. However, while described as being provided by particular subsystems and devices, one of skill in the art in possession of the present disclosure will recognize that third-party subsystem(s) 210 provided in the networked system 200 may include any subsystems and/or devices that may be configured to operate similarly as the third-party subsystem(s) 210 discussed below.

In the illustrated embodiment, the networked system 200 also includes a user location 212 that includes a plurality of devices that are coupled to the network 204, and that may be any location at which an end user may receive a computing device manufactured by the computing device manufacturer system 202. In the specific example illustrated in FIG. 2, the user location 212 includes an orchestrator system 212a that is coupled to the network 204. In an embodiment, the orchestrator system 212a may be provided by the IHS 100 discussed above with reference to FIG. 1 and/or may include some or all of the components of the IHS 100, and in the specific examples below is described as being provided by a virtual machine that may run on one or more server devices to perform edge computing device orchestration for edge computing devices. However, while illustrated and discussed as being provided by a virtual machine running on particular device(s) and performing particular edge computing device orchestration functionality, one of skill in the art in possession of the present disclosure will recognize that the orchestrator system 212a discussed below may be provided by other devices that are configured to operate similarly as the orchestrator system 212a discussed below.

In the specific example illustrated in FIG. 2, the user location 212 includes a management device 212b that is coupled to the network 204. In an embodiment, the management device 212b may be provided by the IHS 100 discussed above with reference to FIG. 1 and/or may include some or all of the components of the IHS 100, and in the specific examples below is described as being provided by a desktop computing device, a laptop/notebook computing device, a tablet computing device, a mobile phone, etc. However, while illustrated and discussed as being provided by particular device(s), one of skill in the art in possession of the present disclosure will recognize that the functionality of the management device 212b discussed below may be provided by other devices that are configured to operate similarly as the management device 212b discussed below. As such, while a specific networked system 200 has been illustrated and described, one of skill in the art in possession of the present disclosure will recognize that the FDO protocol ownership voucher management system of the present disclosure may be provided with a variety of components and component configurations while remaining within the scope of the present disclosure as well.

In the embodiment illustrated in FIG. 2, the rendezvous system 206 is illustrated as coupled to each of the computing device manufacturer system 202 and the user location 212 via the network 204, although one of skill in the art in possession of the present disclosure will appreciate how the rendezvous system 206 may be provided in a variety of manners that will fall within the scope of the present disclosure. For example, the rendezvous system 206 may be provided by the computing device manufacturer system 202, and continuing with the example above in which the computing device manufacturer is DELL® Inc. of Round Rock, Texas, United States, the rendezvous system 206 may be reachable via computing device manufacturer rendezvous system reachability information (e.g., “rendezvous.dell.com”), with the computing device manufacturer system 202 configuring the computing devices discussed below with that computing device manufacturer rendezvous system reachability information during manufacture in such scenarios. In another example, the rendezvous system 206 may be provided by third party system(s) 210 (a VAR in this example), and may be reachable via third party rendezvous system reachability information (e.g., “rendezvous.var.com”), with the computing device manufacturer system 202 configuring the computing devices discussed below with the third party rendezvous system reachability information during manufacture in such scenarios. Further still, in some embodiments, the rendezvous system 206 may be provided by the end user or at the user location 212, and the end user may map (e.g., using Domain Name Server (DNS) mapping techniques) end user rendezvous system reachability information (e.g., “rendezvous.enduser.com”) to the computing device manufacturer rendezvous system reachability information or the third party rendezvous system reachability information discussed above in such scenarios.

As will be appreciated by one of skill in the art in possession of the present disclosure, for any computing device ordered by an end user from a computing device manufacturer or reseller, that end user may wish to provide for the management of that computing device within its own, closed network. For example, military and/or other governmental entities may prevent any external network connections to computing devices they utilize, and thus may require any management of those computing devices (and associated management communications) to remain within a closed network, thus requiring a rendezvous system within that closed network as well. However, many end users will allow external network connections to the computing devices they utilize, and thus a rendezvous system provided by the computing device manufacturer or reseller is an option. As will appreciated by one of skill in the art in possession of the present disclosure, the conventional FDO protocol discussed above does not consider the possibility of different rendezvous system options, while the systems and methods discussed below enable the use of different rendezvous systems via the FDO protocol, and may be configured to provide a “layered FDO rendezvous system onboarding process” that provides an option to use any of a plurality of different rendezvous system options in order to automate FDO protocol functionality in any of the different possible computing device deployment scenarios discussed above.

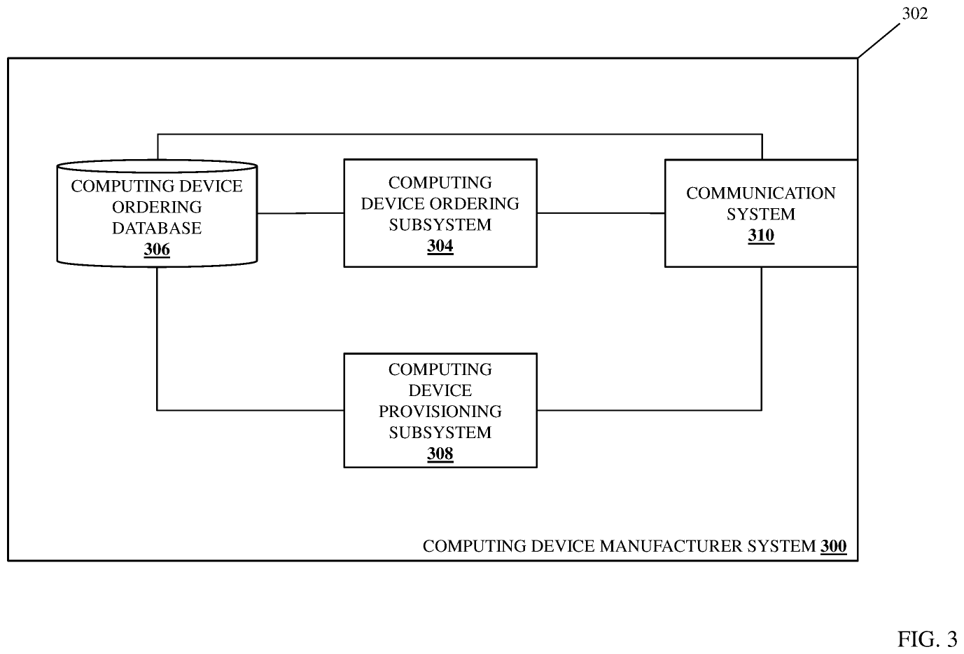

Referring now to FIG. 3, an embodiment of a computing device manufacturer system 300 is illustrated that may provide the computing device manufacturer system 202 discussed above with reference to FIG. 2. As such, the computing device manufacturer system 300 may include one or more of the IHS 100 discussed above with reference to FIG. 1, and is discussed below as including a variety of computing device manufacturer subsystems that allow for the manufacture and provisioning of computing devices to end users and/or third parties. In specific examples the computing device manufacturer system 300 may be provided by DELL® Inc. of Round Rock, Texas, United States (although computing device manufacturing systems provided by other computing device manufacturers will fall within the scope of the present disclosure as well).

In the illustrated embodiment, the computing device manufacturer system 300 includes one or more computing device manufacture locations 302 that one of skill in the art in possession of the present disclosure will recognize may include one or more facilities utilized by a computing device manufacturer to manufacture and provide computing devices to end users and/or third parties (e.g., the resellers discussed herein). For example, the computing device manufacture location(s) 302 may include a computing device ordering subsystem 304. In an embodiment, the computing device ordering subsystem 304 may be provided by the IHS 100 discussed above with reference to FIG. 1 and/or may include some or all of the components of the IHS 100, and in the specific examples below is described as being provided by one or more server devices that are configured to provide for the ordering of computing devices from a computing device manufacturer. However, while illustrated and discussed as being provided by server device(s), one of skill in the art in possession of the present disclosure will recognize that the functionality of the computing device ordering subsystem 304 discussed below may be provided by other devices that are configured to operate similarly as the computing device ordering subsystem 304 discussed below.

The computing device manufacture location(s) 302 may also house one or more storage systems that are coupled to the computing device ordering subsystem 304 and that provide a computing device ordering database 306 that is configured to store computing device order information associated with the ordering of any computing devices from a computing device manufacturer. The computing device manufacture location(s) 302 may also include a computing device provisioning subsystem 304 that is coupled to the computing device ordering database 306 (e.g., via a coupling to the storage system). In an embodiment, the computing device provisioning subsystem 304 may include one or more of the IHS 100 discussed above with reference to FIG. 1, as well as any subsystems that one of skill in the art in possession of the present disclosure will appreciate are configured to manufacture computing devices and provide those computing devices to end users and/or third parties (e.g., the resellers discussed herein). However, while illustrated and discussed as being provided by particular devices and subsystems, one of skill in the art in possession of the present disclosure will recognize that the functionality of the computing device provisioning subsystem 304 discussed below may be provided by other devices and/or subsystems that are configured to operate similarly as the computing device provisioning subsystem 304 discussed below.

The computing device manufacture location(s) 302 may also house a communication system 308 that is coupled to the computing device ordering subsystem 304, the computing device provisioning subsystem 308, and the computing device ordering database 306 (e.g., via a coupling between the communication system 308 and the storage subsystem) and that may be provided by Network Interface Controllers (NICs), wireless communication systems (e.g., BLUETOOTH®, Near Field Communication (NFC) components, WiFi components, cellular components etc.), and/or any other communication components that would be apparent to one of skill in the art in possession of the present disclosure will recognize as allowing the network communications to and from the computing device manufacturer system 300 described below. However, while a specific computing device manufacturer system 300 has been illustrated and described, one of skill in the art in possession of the present disclosure will recognize that computing device manufacturer systems (or other devices and/or subsystems operating according to the teachings of the present disclosure in a manner similar to that described below for the computing device manufacturer system 300) may include a variety of components and/or component configurations for providing conventional computing device manufacturer functionality, as well as the functionality discussed below, while remaining within the scope of the present disclosure as well.

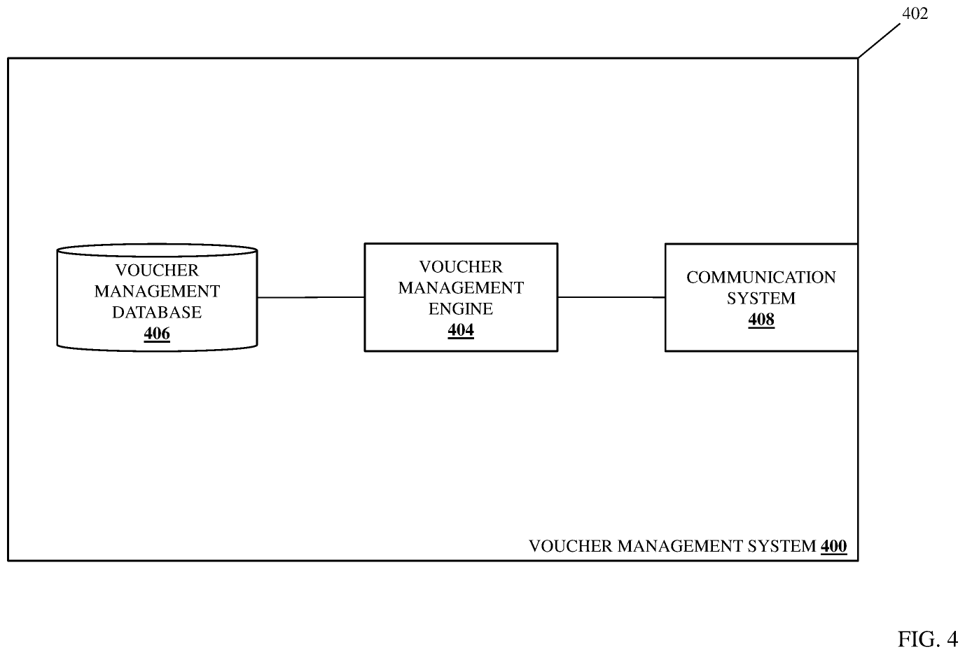

Referring now to FIG. 4, an embodiment of a voucher management system 400 is illustrated that may provide the voucher management system 208 discussed above with reference to FIG. 2. As such, the voucher management system 400 may be provided by the IHS 100 discussed above with reference to FIG. 1 and/or may include some or all of the components of the IHS 100, and in specific examples may be provided by one or more server devices. Furthermore, while illustrated and discussed as being provided by server device(s), one of skill in the art in possession of the present disclosure will recognize that the functionality of the voucher management system 400 discussed below may be provided by other devices that are configured to operate similarly as the voucher management system 400 discussed below. In the illustrated embodiment, the voucher management system 400 includes a chassis 402 that houses the components of the voucher management system 400, only some of which are illustrated and discussed below. For example, the chassis 402 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a voucher management engine 404 that is configured to perform the functionality of the voucher management engines, voucher management subsystems, and/or voucher management systems discussed below.

The chassis 402 may also house a storage system (not illustrated, but which may include the storage 108 discussed above with reference to FIG. 1) that is coupled to the voucher management engine 404 (e.g., via a coupling between the storage system and the processing system) and that includes a voucher management database 406 that is configured to store any of the information utilized by the voucher management engine 404 discussed below. The chassis 402 may also house a communication system 408 that is coupled to the voucher management engine 404 (e.g., via a coupling between the communication system 408 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. However, while a specific voucher management system 400 has been illustrated and described, one of skill in the art in possession of the present disclosure will recognize that voucher management system (or other devices operating according to the teachings of the present disclosure in a manner similar to that described below for the voucher management system 400) may include a variety of components and/or component configurations for providing conventional voucher management functionality, as well as the functionality discussed below, while remaining within the scope of the present disclosure as well.

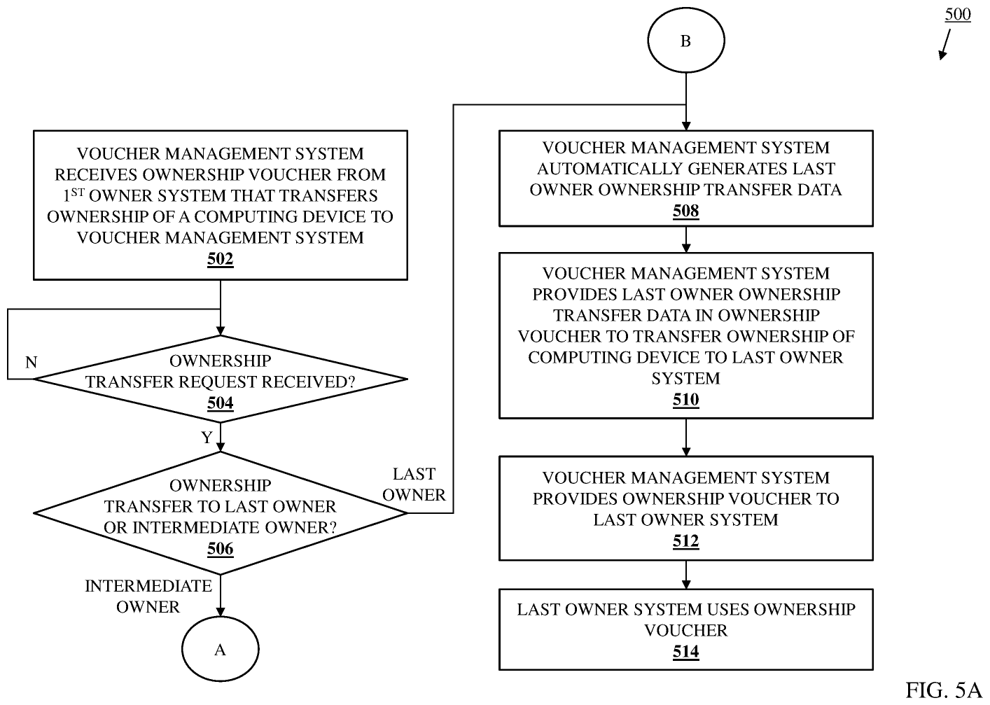

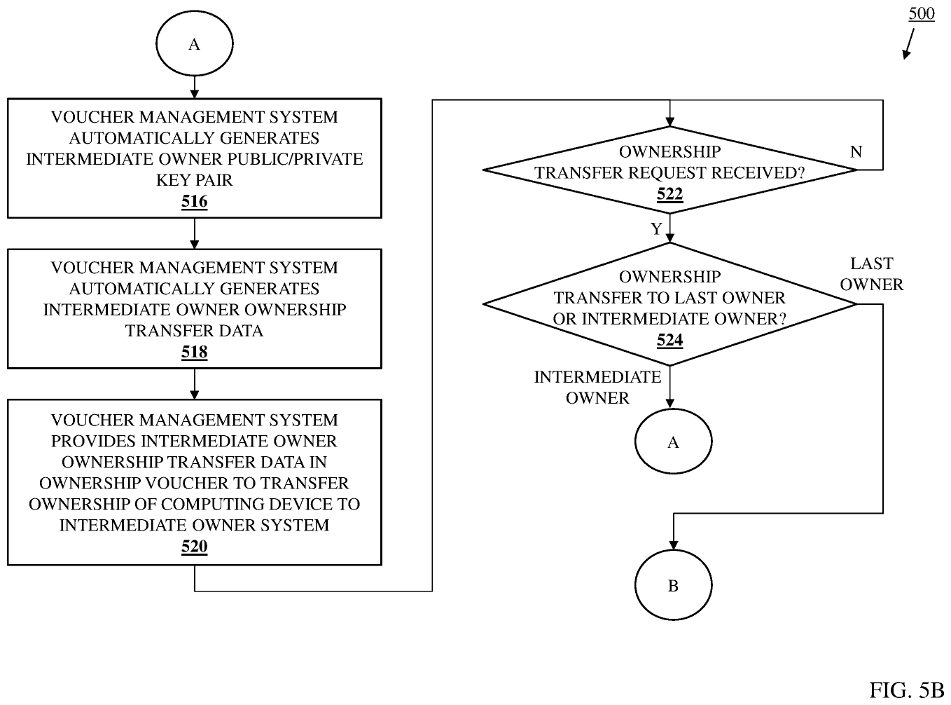

Referring now to FIGS. 5A and 5B, an embodiment of a method 500 for managing ownership vouchers is illustrated. As discussed below, the systems and methods of the present disclosure provide an ownership voucher management system that manages ownership vouchers utilized in the FDO protocol in order to facilitate the transfer of ownership of a computing device from a first owner to a last owner, and in some cases between one or more intermediate owners between the first owner and the last owner. For example, the FIDO protocol ownership voucher management system of the present disclosure may be provided in a networked system including a first owner system and a second owner system coupled to a voucher management system. The voucher management system receives, from the first owner system, an ownership voucher having first ownership transfer data including a voucher management system public key that has been signed by a first owner system private key in order to transfer ownership of a computing device from the first owner system to the voucher management system. The voucher management system determines that the ownership of the computing device should be transferred to the second owner system and, in response, automatically generates second ownership transfer data by signing a second owner system public key with a voucher management system private key, and provides the second ownership transfer data in the ownership voucher in order to transfer ownership of the computing device from the voucher management system to the second owner system. As such, the transfer ownership of a computing device between owners in a supply chain using ownership vouchers according to the FIDO protocol is simplified for owners.

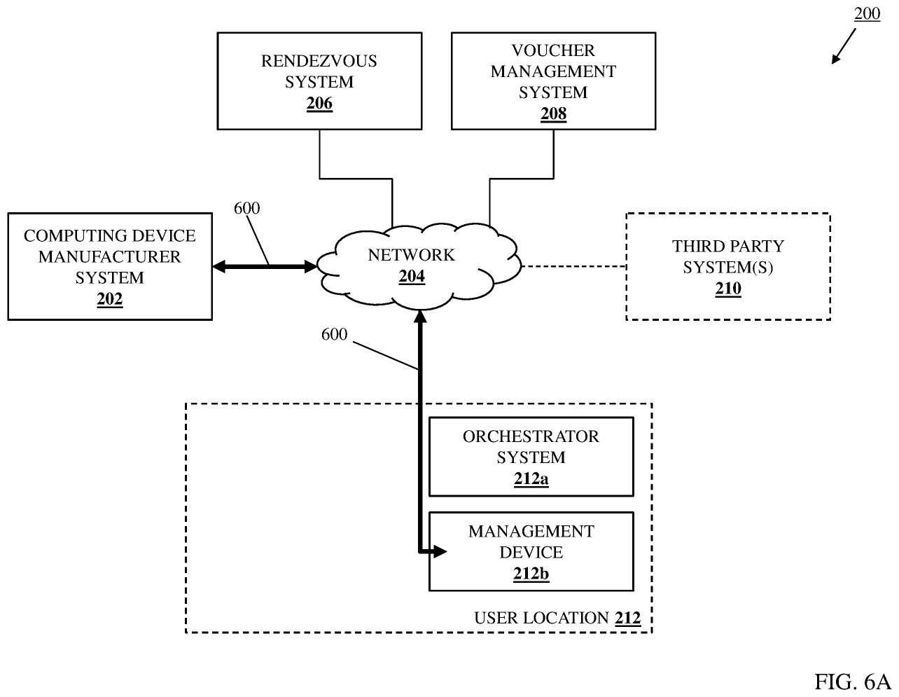

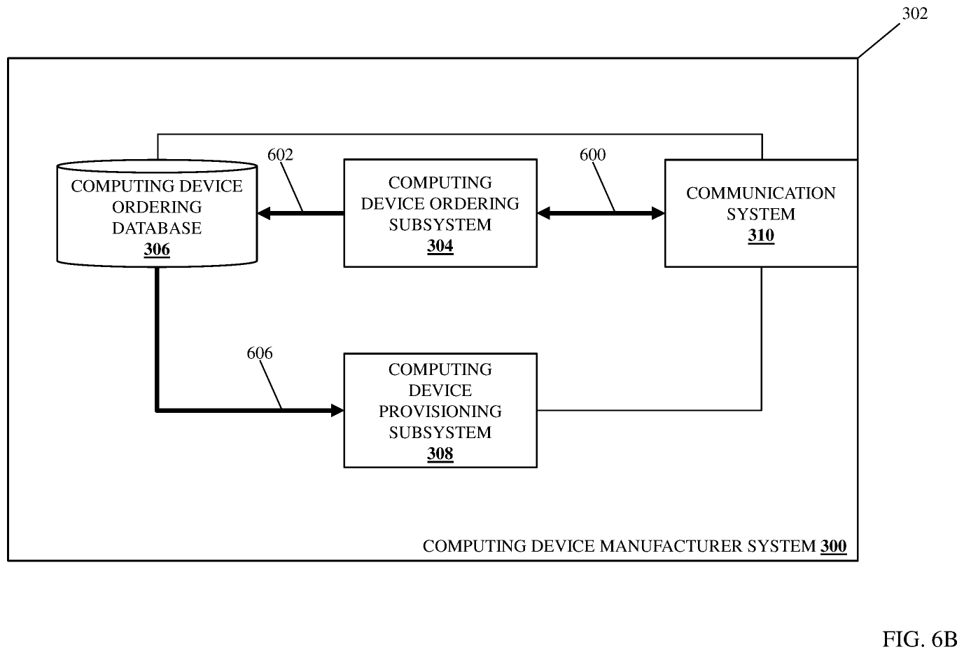

The method 500 begins at block 502 where a voucher management system receives an ownership voucher from a first owner system that transfers ownership of a computing device to the voucher management system. In an embodiment, during or prior to the method 500, an “end user” at the user location 212 (also called a “last owner” below) may order a computing device from the computing device manufacturer system 202 (the “first owner system” in this example). For example, with reference to FIGS. 6A and 6B, the management device 212b may perform computing device ordering operations 600 that include exchanging computing device ordering communications via the network 204 and with the computing device ordering subsystem 304 in the computing device manufacturing system 300 via the communication system 310. As illustrated in FIG. 6B, the computing device ordering subsystem 304 may then perform computing device ordering information storage operations 602 that include storing any of a variety of computing device ordering information generated during the computing device ordering operations 600 in the computing device ordering database 306 included in the computing device manufacturer system 300 (e.g., a sales database at a computing device manufacturer). Furthermore, the computing device provisioning subsystem 308 in the computing device provisioning subsystem 300 may perform computing device ordering information utilization operations 606 to utilize any of the computing device ordering information stored in the computing device ordering database 306 in order to provide for the manufacture of the computing device that was ordered by the end user.

In some of the specific examples below, the end user that ordered the computing device may be considered a “subsequent” owner of the computing device (i.e., they will own the computing device immediately subsequent to the computing device manufacturer that is the “original owner” of the computing device). However, as discussed below, the “subsequent owner” of the computing device may be provided by a third party/reseller who then later provides that computing device to the “last owner”/end user. In either situation, the computing device ordering operations 600 may include the computing device ordering subsystem 304 identifying a subsequent owner identifier for the subsequent owner that ordered the computing device from the computing device manufacturer system 202, and associating that subsequent owner identifier with the computing device ordering information for that computing device in the computing device ordering database 306.

Furthermore, in a specific example of the ordering of the computing device by the subsequent owner from the computing device manufacturer system 300, the computing device ordering operations 600 may include the subsequent owner (e.g., the end user using the management device 212b, the third party/reseller using the third party system 210, etc.) and the computing device ordering subsystem 304 communicating so that the computing device ordering subsystem 304 may identify the rendezvous system reachability information discussed above for at least one rendezvous system. For example, in the event that the subsequent owner will have the computing device manufacturer manage the computing device being ordered, the subsequent owner may specify rendezvous system reachability information for a rendezvous system managed by the computing device manufacturer (e.g., “rendezvous.dell.com” in the specific example above). Furthermore, in some examples the rendezvous system reachability information for the rendezvous system managed by the computing device manufacturer may be provided in the computing device as a default rendezvous system reachability information option, with the rendezvous system reachability information for the rendezvous system managed by the computing device manufacturer described as “global rendezvous system reachability information” in the some of examples below.

In another example, in the event that the subsequent owner is a third party/reseller that will manage the computing device being ordered, the subsequent owner may specify rendezvous system reachability information for a rendezvous system managed by the third party/reseller (e.g., “rendezvous.var.com” in the specific example above). Furthermore, in some examples the rendezvous system reachability information for the rendezvous system managed by the third party/reseller may be provided in the computing device with the default rendezvous system reachability information option discussed above, with the rendezvous system reachability information for the rendezvous system managed by the third party/reseller described as “reseller local rendezvous system reachability information” in the examples below.

In another example, in the event that the subsequent owner is an end user that will manage the computing device being ordered, the subsequent owner may specify rendezvous system reachability information for a rendezvous system managed by the end user (e.g., “rendezvous.enduser.com” in the specific example above). Furthermore, in some examples the rendezvous system reachability information for the rendezvous system managed by the end user may be provided in the computing device with the default rendezvous system reachability information option discussed above, with the rendezvous system reachability information for the rendezvous system managed by the end user described as “end user local rendezvous system reachability information” in the examples below.

As such, rendezvous system reachability information may be identified by the computing device ordering subsystem 304 during the computing device ordering operations 600 and may include global rendezvous system reachability information that is identified via the communications with the subsequent owner or in response to no rendezvous system reachability information being explicitly provided by the subsequent owner (in which case that “default”/global rendezvous system reachability information may be retrieved by the computing device ordering subsystem 304 from a database in the computing device manufacturer system 300), reseller local rendezvous system reachability information that is identified via the communications with the subsequent owner/reseller, and/or end user local rendezvous system reachability information that is identified via the communications with the subsequent owner/end user. As discussed above, the computing device ordering information storage operations 602 may include storing any of the rendezvous system reachability information identified during the computing device ordering operations 600 in the computing device ordering database 306.

In a specific example, the manufacture of the computing device ordered by the end user may include performing any of a variety of other computing device manufacturing operations that one of skill in the art in possession of the present disclosure would recognize as providing for the functionality discussed below. For example, the manufacture of the computing device ordered by the end user may include operating and utilizing information according to the FDO-DI protocol to provide a “pointer” (e.g., the rendezvous system reachability information discussed above) to the rendezvous system 206 in the computing device, generate a public/private key pair (e.g., a computing device public key and a corresponding computing device private key), and generate a hash of the computing device manufacturer public key, and storing the pointer, computing device private key, and the hash of the computing device manufacturer key in the computing device (e.g., using a Trusted Execution Environment (TEE) such as a Trusted Platform Module (TPM) in the computing device). In a specific example, the manufacture of the computing device may include providing an FDO client in the TEE in the computing device that operate to maintain device ownership credentials provided by the rendezvous system reachability information/pointer, the computing device private key, and the hash of the computing device manufacturer public key.

In a specific example of the manufacture of the computing device ordered by the end user, the computing device provisioning subsystem may retrieve the rendezvous system reachability information identified during the computing device ordering operations 600 from the computing device ordering database 306, and provide the rendezvous system reachability information in the computing device ordered by the end user. As will be appreciated by one of skill in the art in possession of the present disclosure, in some embodiments the rendezvous system reachability information provided in the computing device ordered by the end user may include a single pointer to the rendezvous system 206 (e.g., the “rendezvous.dell.com” pointer to the rendezvous system managed by the computing device manufacturer, the “rendezvous.var.com” pointer to the rendezvous system managed by the third party/reseller, or the “rendezvous.enduser.com” pointer to the rendezvous system managed by the end user, each of which is described above).

However, as also discussed above, in some embodiments, the rendezvous system reachability information provided in the computing device ordered by the end user may include multiple pointers to different rendezvous systems in order to provide the “layered FDO rendezvous system onboarding process” discussed in further detail below. Continuing with the specific example above, the rendezvous system reachability information provided in the computing device ordered by the end user may prioritize pointers to different rendezvous systems by providing the global rendezvous system reachability information (e.g., the “rendezvous.dell.com” pointer to the rendezvous system managed by the computing device manufacturer) with the highest priority, as well as providing at least one of the reseller local rendezvous system reachability information (e.g., the “rendezvous.var.com” pointer to the rendezvous system managed by the third party/reseller) with an intermediate priority, and the end user local rendezvous system reachability information (e.g., the “rendezvous.enduser.com” pointer to the rendezvous system managed by the end user) with a lowest priority. However, while a specific example of prioritized rendezvous system reachability information is provided above, one of skill in the art in possession of the present disclosure will appreciate how rendezvous system reachability information may be prioritized in the computing device for any plurality of rendezvous systems in order to configure the computing device to contact the plurality of rendezvous systems based on the priority of their rendezvous system reachability information, discussed below, while remaining within the scope of the present disclosure as well.

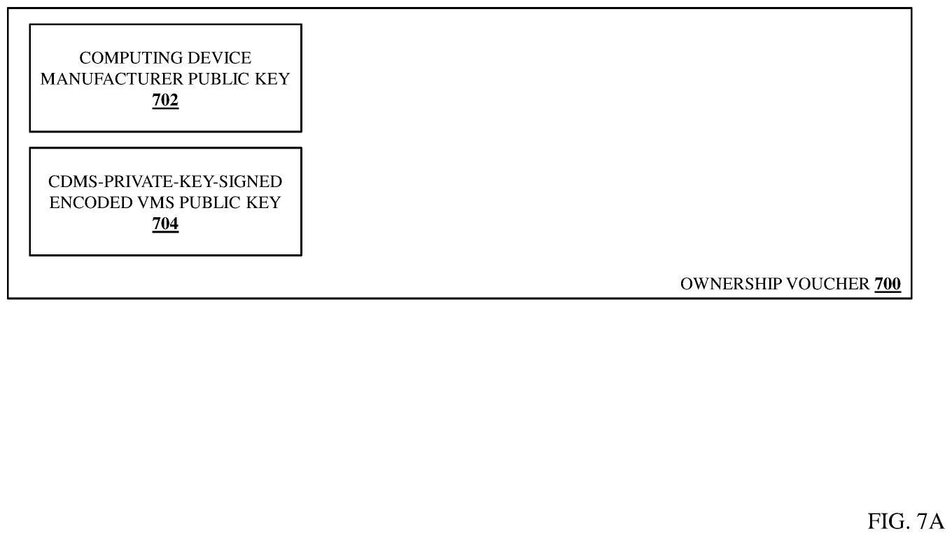

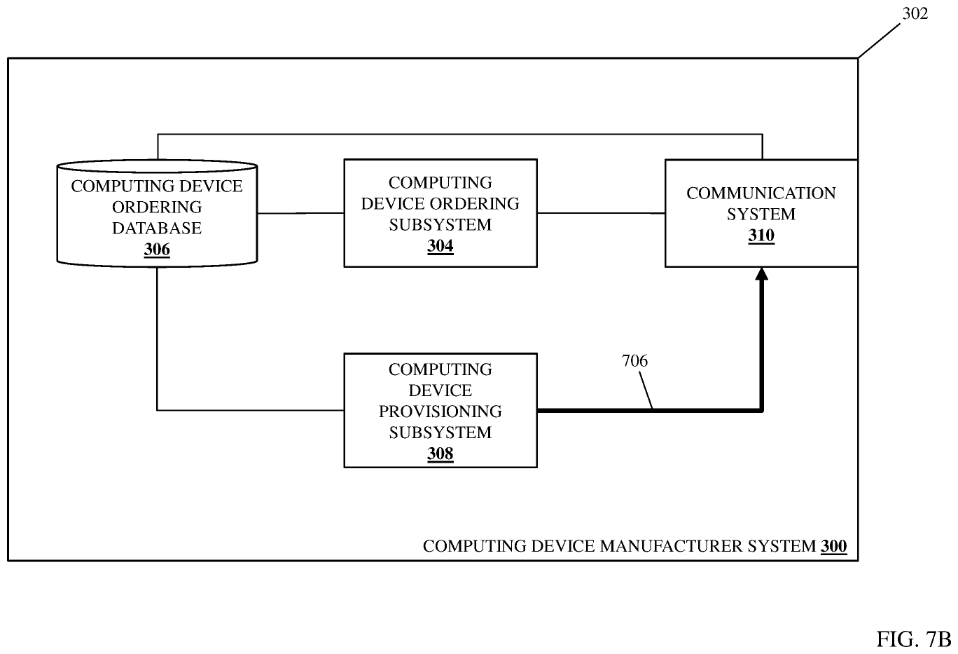

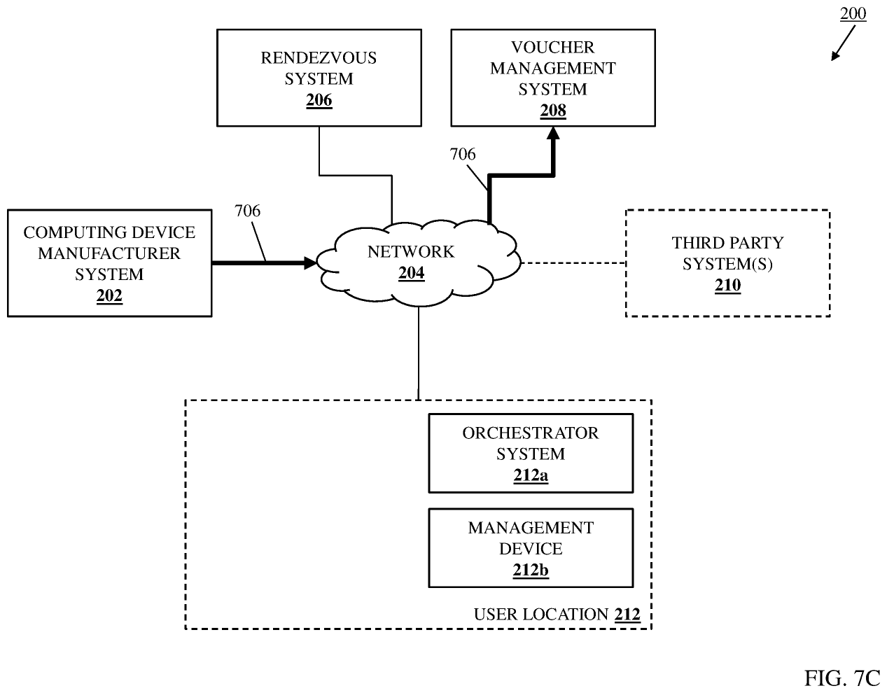

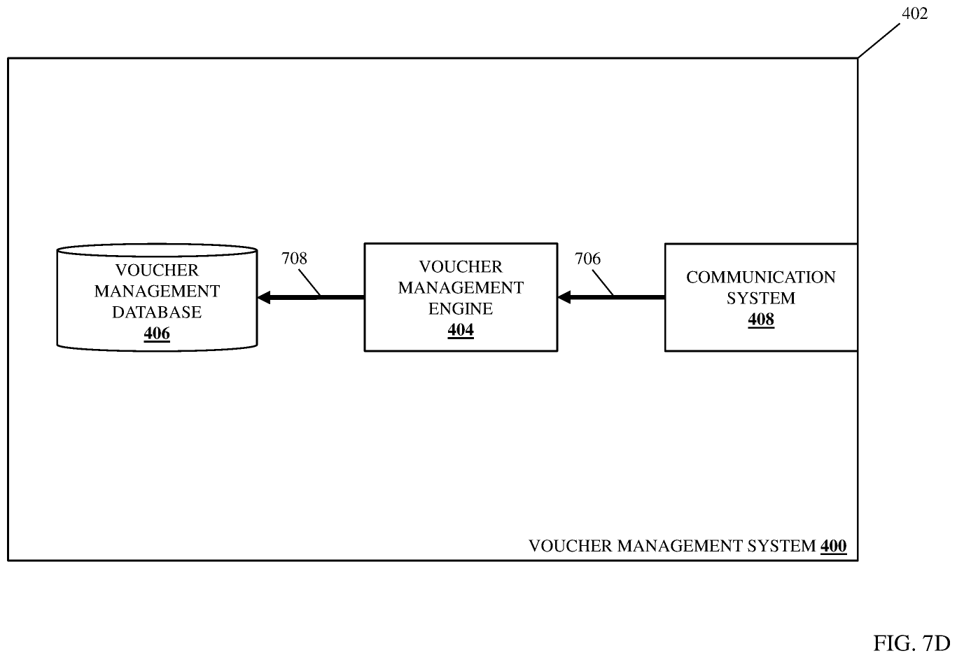

In an embodiment, at block 502, the computing device provisioning subsystem 308 may perform computing device ownership transfer operations that include generating an ownership voucher for the computing device ordered by the end user, and using the ownership voucher to transfer ownership of the computing device ordered by the end user to the voucher management system 208. With reference to FIG. 7A, the computing device provisioning subsystem 308 may generate an ownership voucher 700 that includes a computing device manufacturer public key 702 of the computing device manufacturer (e.g., a computing device manufacturer public key hash value generated by performing a hashing operation on a computing device manufacturer public key). Furthermore, the computing device provisioning subsystem 308 may use the ownership voucher 700 to transfer ownership of the computing to the voucher management system 208 by using a computing device manufacturer system (CDMS) private key controlled by the computing device manufacturer to sign an encoded voucher management system (VMS) public key of the voucher management system 208 to generate a CDMS-private-key-signed encoded VMS public key 704, and providing that CDMS-private-key-signed encoded VMS public key 704 in the ownership voucher 700. However, while a simplified version of the ownership voucher 700 is illustrated and described below, one of skill in the art in possession of the present disclosure will recognize that an ownership voucher provided according to the FDO protocol may include a hash of the computing device public key, the computing device manufacturer public key, and the computing device public key.

In a specific example, the computing device provisioning subsystem 308 may generate the CDMS-private-key-signed encoded VMS public key 704 according to the FDO protocol by retrieving a VMS public key of the voucher management system 208, and performing a hashing operation on a combination of that VMS public key, a Globally Unique IDentifier (GUID) for the computing device that was ordered by the end user, computing device information associated with the computing device that was ordered by the end user (e.g., serial number(s), Media Access Control (MAC) address(es), etc.), and/or other any other information that would be apparent to one of skill in the art in possession of the present disclosure, in order to generate an encoded VMS public key. The computing device provisioning subsystem 308 may then sign that encoded VMS public key with the CDMS private key to provide the CDMS-private-key-signed encoded VMS public key 704. However, while a specific example of the generation of the CDMS-private-key-signed encoded VMS public key 704 has been described, one of skill in the art in possession of the present disclosure will appreciate how the computing device provisioning subsystem 308 may perform other operations according to the FDO protocol in order to transfer ownership of the computing device ordered by the end user to the voucher management system 208 using the ownership voucher 700 while remaining within the scope of the present disclosure.

For example, the discussion of the signing of the VMS public key using the CDMS private key above implies that the portion of the computing device provisioning subsystem 308 that generates ownership vouchers has access to the CDMS private key. However, in some situations, the computing device provisioning subsystem 308 may separate the portion of the computing device provisioning subsystem 308 that generates ownership vouchers from the portion of the computing device provisioning subsystem 308 at which computing devices are “built” (e.g., assembled and/or otherwise manufactured), with the portion of the computing device provisioning subsystem 308 at which computing devices are built implementing security protocols in association with the CDMS private key. As such, the computing device provisioning subsystem 308 may include a private key signing module that is controlled by the portion of the computing device provisioning subsystem 308 at which computing devices are built, and an ownership voucher generation module that is separate from the private key signing module and included in the portion of the computing device provisioning subsystem 308 that generates ownership vouchers.

In such embodiments, the ownership voucher generation module in the computing device provisioning subsystem 308 may operate to retrieve the VMS public key from the voucher management system 208, and use a secure Application Programming Interface (API) to provide the VMS public key to the private key signing module with an instruction to sign that VMS public key with the CDMS private key. When the private key signing module in the computing device provisioning subsystem 308 receives the VMS public key and corresponding instruction via the secure API, it may operate to sign the VMS public key using the CDMS private key to generate the first ownership transfer data, and may use the secure API to transfer the first ownership transfer data back to the ownership voucher generation module. In response to receiving the first ownership transfer data from the private key signing module via the secure API, the ownership voucher generation module may then provide the first ownership transfer data in the ownership voucher. As such, the computing device manufacturer system 202 may implement a secure API to ensure security of the CDMS private key while separating the “building” of computing device from the ownership voucher generation for those computing devices.

With reference to FIGS. 7B, 7C, and 7D, at block 502 the computing device manufacturer system 300 may perform ownership voucher transmission operations 706 that include the computing device provisioning subsystem 308 transmitting the ownership voucher 700 (i.e., with the CDMS-private-key-signed encoded VMS public key 704) via the communication system 310 and through the network 204 to the voucher management system 208. For example, the ownership voucher transmission operations 706 performed by the computing device manufacturer system 300 may utilize a secure Application Programming Interface (API) and/or any other security techniques that would be apparent to one of skill in the art in possession of the present disclosure in order to securely transmit the ownership voucher 700 to the voucher management system 208. As such, at block 502, the voucher management engine 404 in the voucher management system 208/400 may receive the ownership voucher 700 via its communication system 408 from the computing device manufacturer system 202 (e.g., a “first owner system” in this example) that transfers ownership of the computing device ordered by the end user to the voucher management system 208, and the voucher management engine 404 in the voucher management system 208/400 may perform ownership voucher storage operations 708 that include storing the ownership voucher 700 in its voucher management database 406.

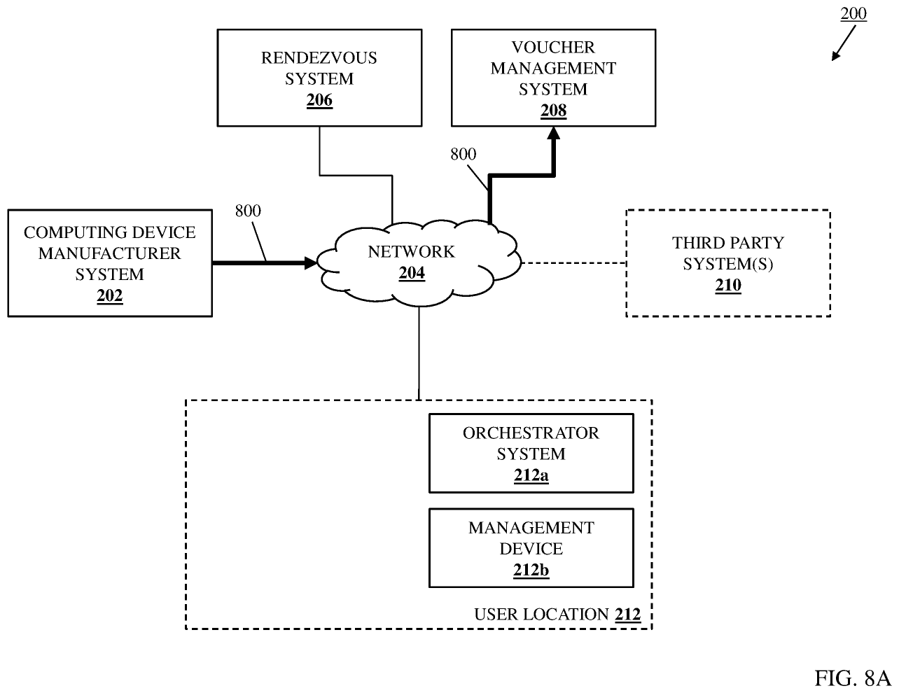

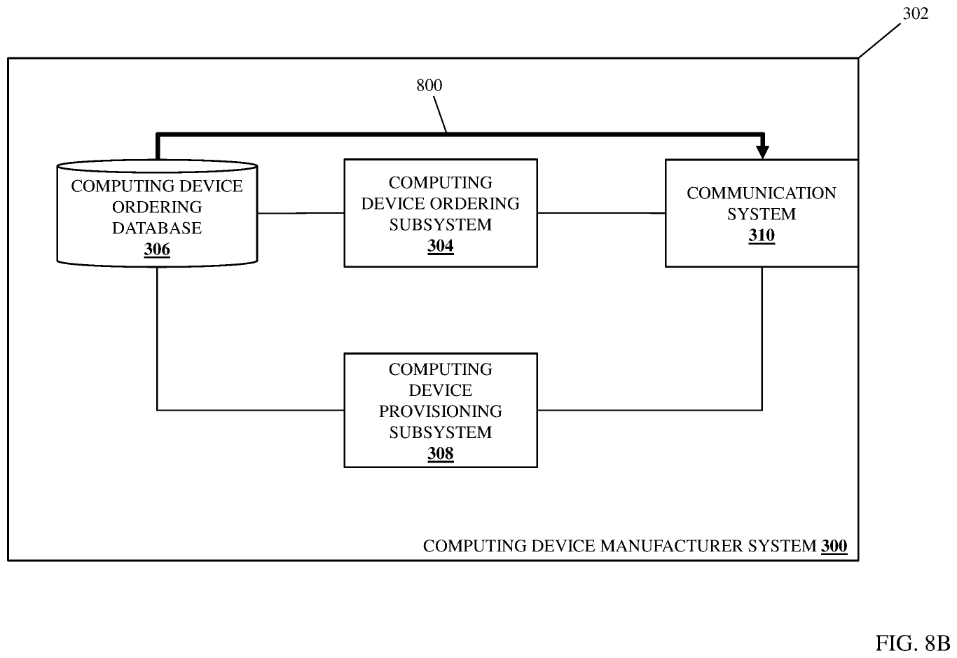

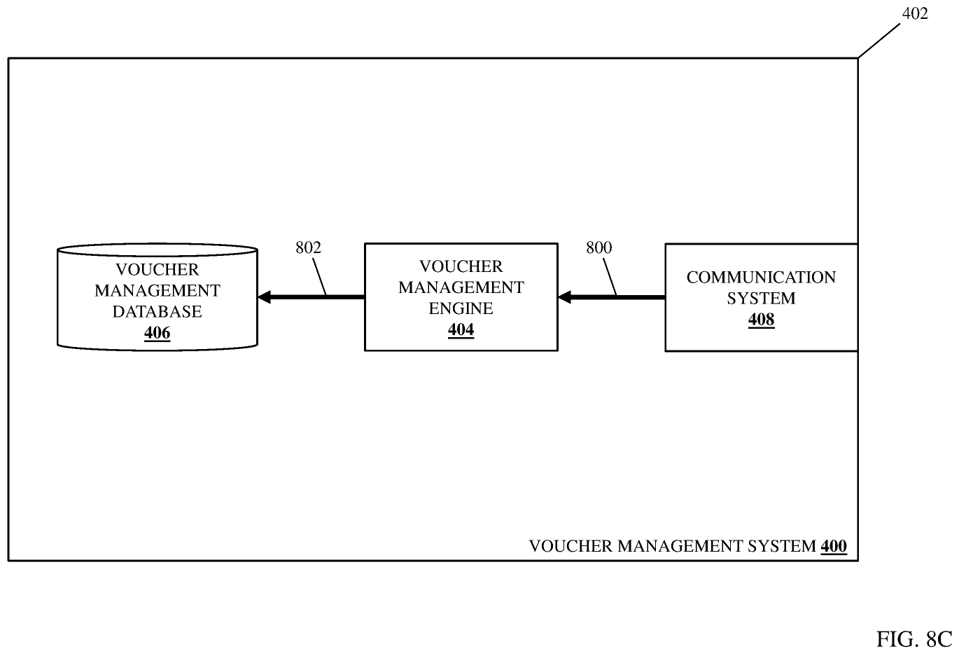

With reference to FIGS. 8A, 8B, and 8C, at block 502 and in response to receiving the ownership voucher 700, the voucher management engine 404 in the voucher management system 208/400 may perform computing device ordering information retrieval operations 800 that include the voucher management engine 404 accessing the computing device ordering database 306 in the computing device manufacturer system 300 via the network 204 and its communication system 310 in order to retrieve any of the computing device ordering information about the computing device ordered by the end user. The voucher management engine 404 in the voucher management system 208/400 may then perform computing device ordering information/ownership voucher mapping operations 802 that include mapping any of the computing device ordering information to the ownership voucher 700 in the voucher management database 406.

Furthermore, the ownership voucher mapping operations 802 may also include the voucher management engine 404 in the voucher management system 208/400 mapping the ownership voucher to the subsequent owner identifier that was associated with the computing device ordering information in the computing device ordering database 306 as discussed above. As such, the ordering of the computing device may result in a subsequent owner identifier for the subsequent owner (e.g., the end user or reseller discussed above), the computing device ordering information, and the ownership voucher being mapped to each other, thus allowing the subsequent owner and computing device to subsequently access the ownership voucher as discussed in further detail below.

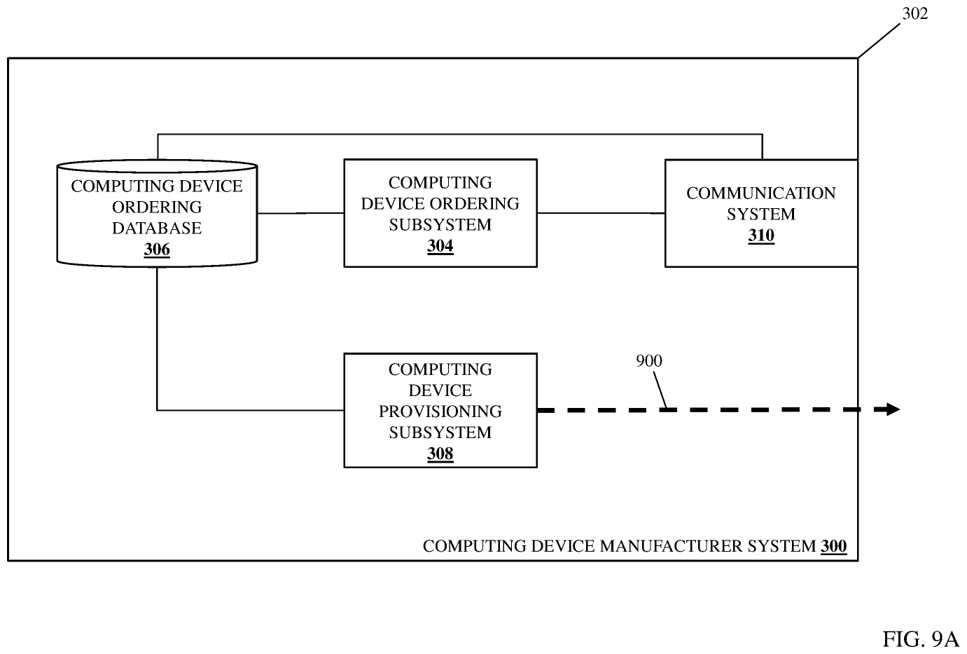

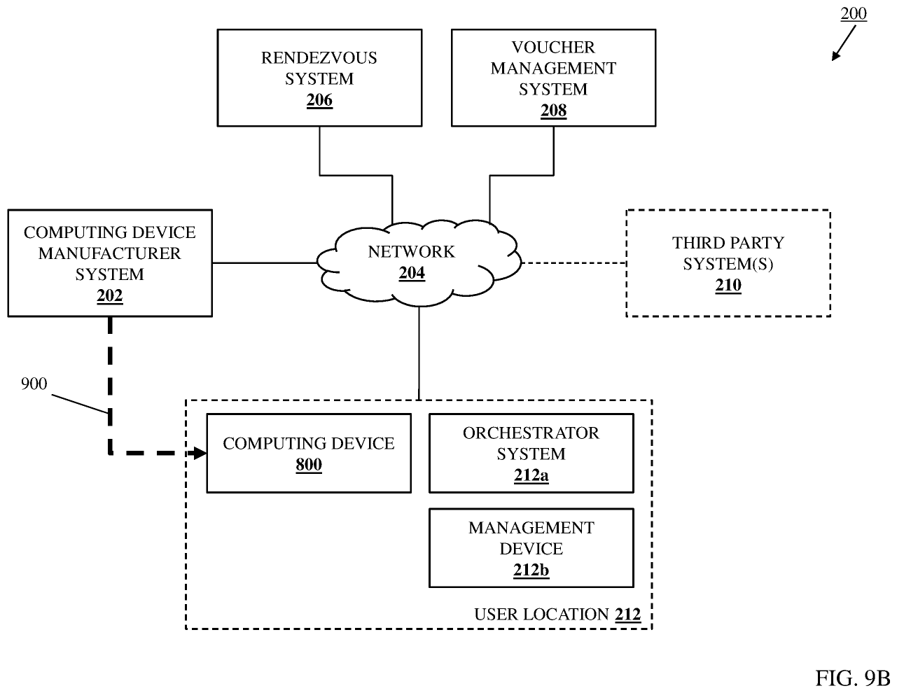

With reference to FIGS. 9A and 9B, subsequent to the completion of the manufacturing of the computing device ordered by the end user, the computing device manufacturer system 300 may perform computing device provisioning operations 900 that include the computing device provisioning subsystem 308 in the computing device manufacturer system 202/300 providing a computing device 800 (the computing device that was ordered by the end user as discussed above) to the user location 212. As will be appreciated by one of skill in the art in possession of the present disclosure, the computing device provisioning operations 900 may be performed by shipping the computing device 800 that was ordered by the end user and manufactured by the computing device manufacturer system 202/300 to the user location 212 for use by the end user. As such, following block 502, the computing device 800 may be located at the user location 212, and the ownership voucher 700 may be stored at the voucher management system 208 and may indicate that the voucher management system 208 owns the computing device 800.

The method 500 then proceeds to decision block 504 where it is determined whether an ownership transfer request has been received. In an embodiment, at decision block 504, the voucher management engine 404 in the voucher management system 208/400 may operate to monitor for any ownership transfer requests that request the transfer of ownership of the computing device 800 to a different owner. As discussed above, at block 502 the voucher management system 208 was defined as the owner of the computing device 800 using the ownership voucher 700, and thus any request received by the voucher management engine 404 to transfer ownership of the computing device 800 to a “new” owner other than the voucher management system 208 may be recognized as the ownership transfer request at decision block 504. If, at decision block 504, it is determined that an ownership transfer request has not been received, the method 500 returns to decision block 504. As such, the method 500 may loop such that the voucher management engine 404 in the voucher management system 208/400 continues to monitor for any ownership transfer requests that request the transfer of ownership of the computing device 800 to a different owner (e.g., until an ownership transfer request is received).

If, at decision block 504, it is determined that an ownership transfer request has been received, the method 500 proceeds to decision block 506 where the method proceeds depending on whether the ownership transfer is to a last owner or an intermediate owner. In the first example provided herein, a “direct” computing-device-manufacturer-to-end-user scenario is described in which ownership of the computing device is transferred directly from the voucher management system 208 to the end user that ordered the computing device 800 (a “last owner” in that example) without having any intermediate owners in between. As will be appreciated by one of skill in the art in possession of the present disclosure, such a scenario may exist when end users order their computing devices directly from the computing device manufacturer such that those computing devices are shipped from or otherwise provided by the computing device manufacturer to the end user. However, in a second example provided below, an “indirect” computing-device-manufacturer-to-end-user scenario is described in which ownership of the computing device is transferred from the voucher management system 208 to one or more third parties (“intermediate owner(s)” in that example) before being transferred to the end user that ordered the computing device 800 (a “last owner” in this example). As will be appreciated by one of skill in the art in possession of the present disclosure, such a scenario may exist when end users order their computing devices from resellers that received those computing device either from the computing device manufacturer or other resellers, with those computing devices shipped from or provided by one of the resellers to the end user.

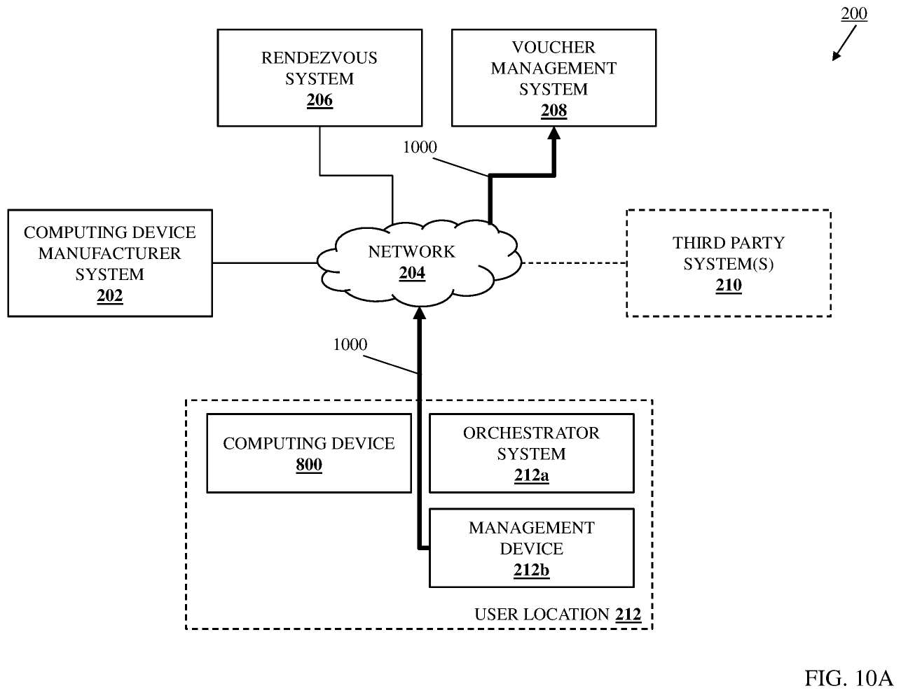

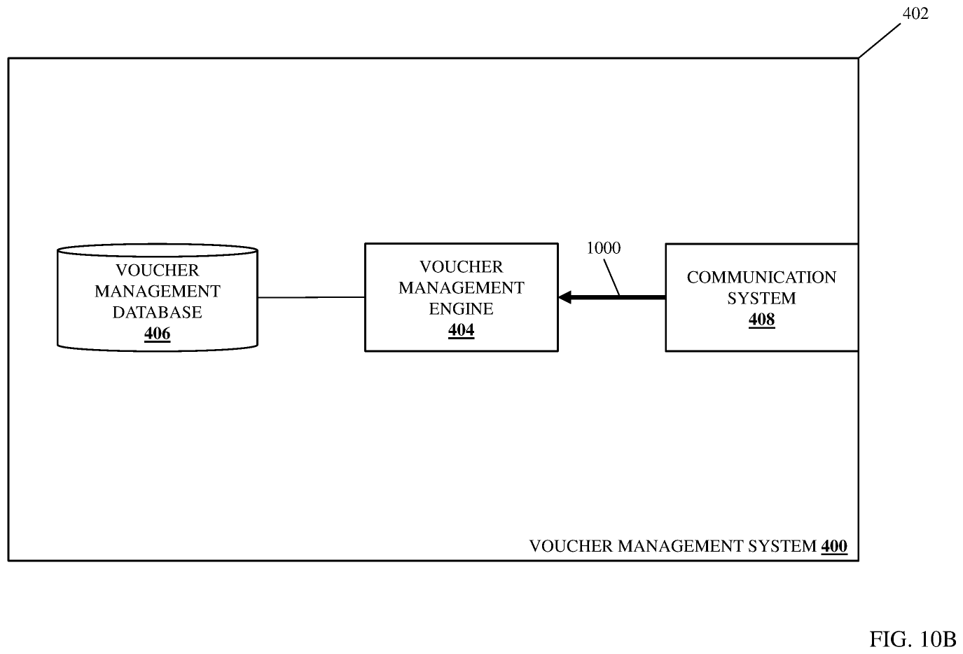

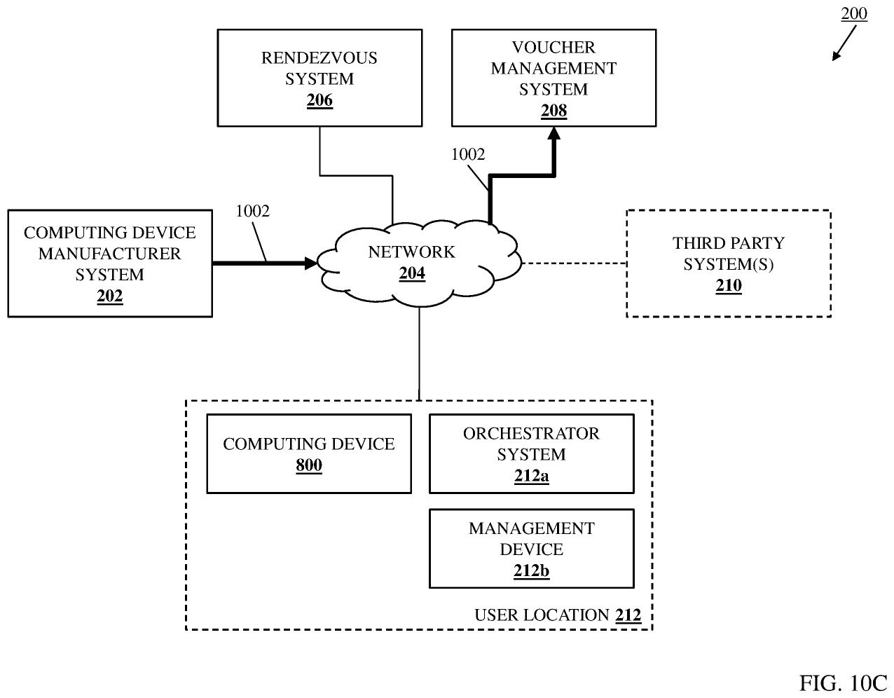

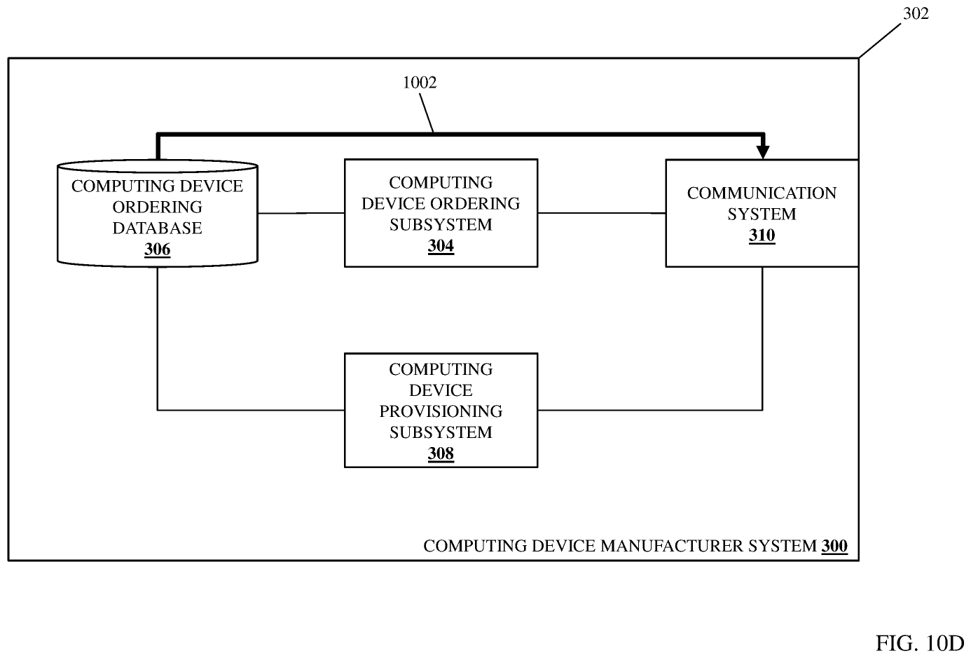

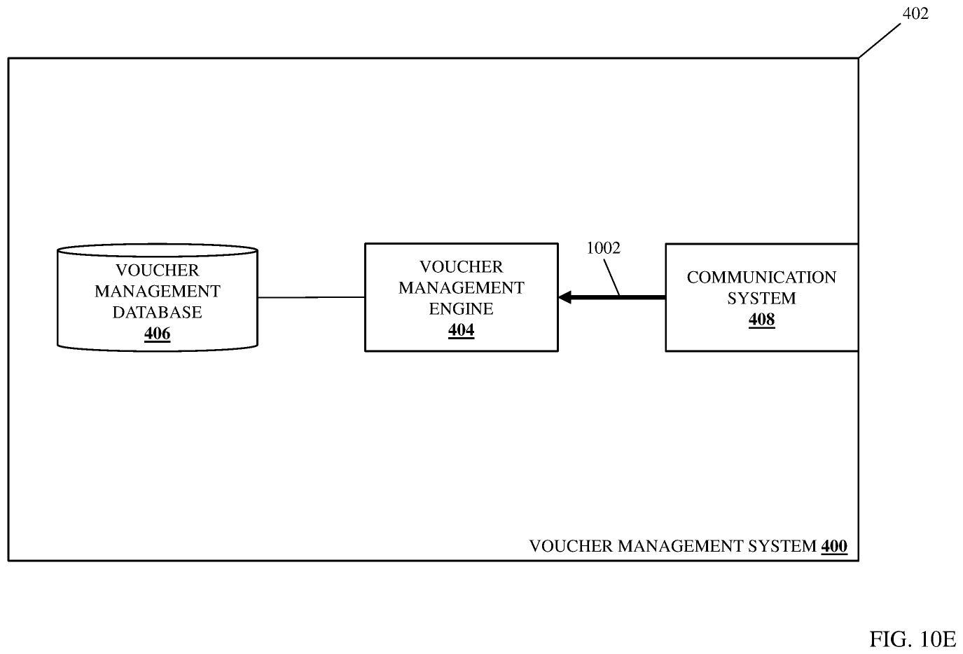

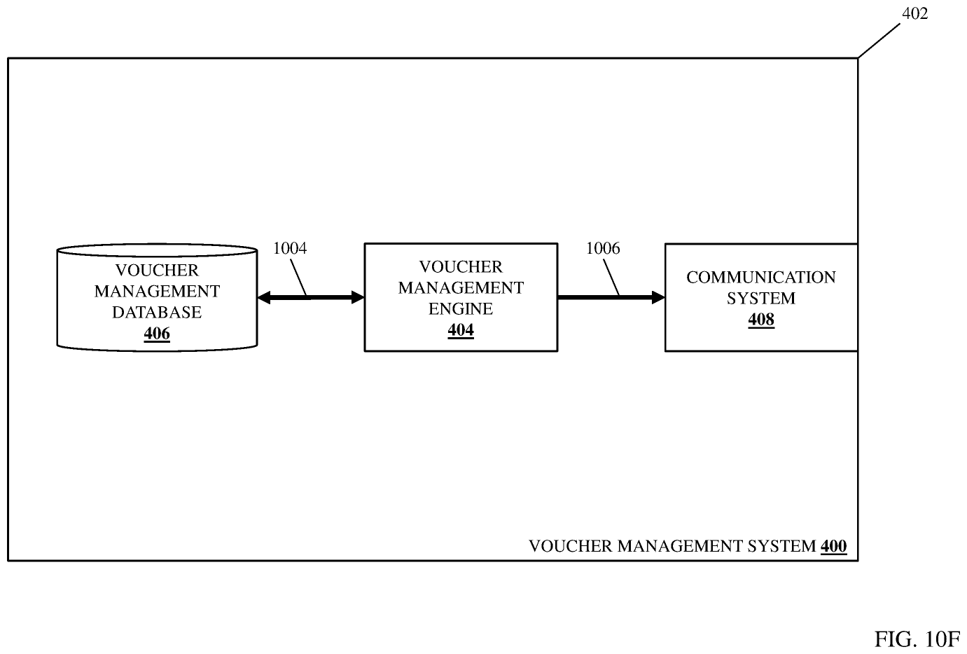

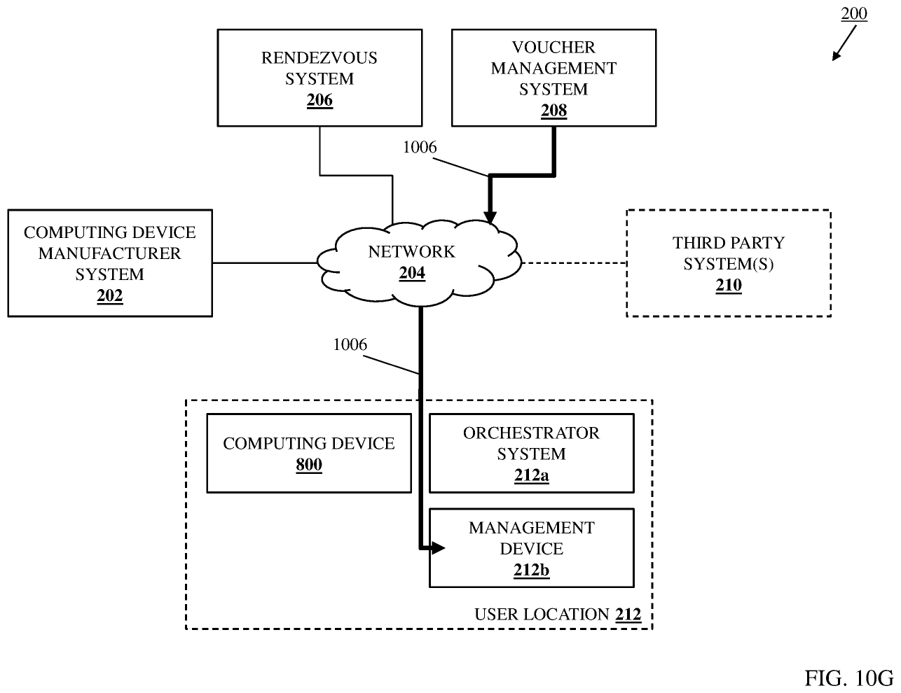

If, at decision block 506, the ownership transfer is to a last owner, the method 500 proceeds to block 508 where the voucher management system automatically generates last owner ownership transfer data. With reference to FIGS. 10A and 10B, in an embodiment of decision blocks 504 and 506, the end user that received the computing device 800 at the user location 212 may utilize the management device 212b at the user location 212 to perform voucher management system access operations 1000 that include accessing the voucher management system 208 via the network 204 (e.g., via a “support” website provided by the computing device manufacturer such as “support.dell.com” using the specific example provided above). For example, the voucher management system access operations 1000 may include the end user using the management device 212b to perform Single Sign-On (SSO) operations with the voucher management engine 404 via its communication system 408, which one of skill in the art in possession of the present disclosure will recognize provides a session and user authentication service that may permit the end user to use one set of login credentials to access multiple applications provided by the voucher management system 208, as well as perform other SSO functionality known in the art in order to authenticate to the voucher management system 208.

In an embodiment, the voucher management system access operations 1000 may include the end user using the management device 212b providing an orchestrator system (OS) public key of the orchestrator system 212a to the voucher management system 208. As discussed in further detail below, in the examples provided herein, the orchestrator system 212a provides a “last owner system” to which ownership of the computing device 800 will provided using the ownership voucher 700, and the OS public key may be provided to the voucher management system 208 in order to allow that ownership transfer to be performed.

With reference to FIGS. 10C, 10D, and 10E, in an embodiment of decision blocks 504 and 506 and in response to authenticating the end user, the voucher management engine 404 in the voucher management system 208 may perform computing device ordering information retrieval operations 1002 that include the voucher management engine 404 accessing the computing device ordering database 306 in the computing device manufacturer system 300 via the network 204 and its communication system 310 in order to retrieve any computing device ordering information about computing device(s) ordered by the end user that was authenticated. With reference to FIG. 10F, the voucher management engine 404 in the voucher management system 208/400 may then perform end user/ownership voucher identification operations 1004 that include the voucher management engine 404 using the computing device ordering information about computing device(s) ordered by the end user that was authenticated to identify any ownership vouchers (e.g., including the ownership voucher 700 discussed above) in the voucher management database 406 associated with computing devices ordered by the end user.

With reference to FIGS. 10F and 10G, in an embodiment of decision blocks 504 and 506, the voucher management engine 404 in the voucher management system 208/400 may then perform ownership voucher display operations 1006 that include providing, for display via the network 204 using its communication system 408, any of the ownership vouchers identified for the end user for display on the management device 212b (e.g., via the “support” website provided by the computing device manufacturer such as “support.dell.com” using the specific example provided above). As such, one of skill in the art in possession of the present disclosure will recognize that the voucher management system 208 may provide a single, centralized location/source for the end user to review any ownership vouchers that define the ownership of any computing devices ordered by the end user. As will be appreciated by one of skill in the art in possession of the present disclosure, such a single, centralized location/source for ownership vouchers review may be particularly beneficial to end users that order hundreds, and even thousands, of computing devices from the computing device manufacturer or third parties.

As such, an embodiment of decision blocks 504 and 506 may include the end user using the management device 212b to select one or more ownership vouchers that were provided for display by the voucher management system 208 on the management device 212b in order to transmit the ownership transfer request for those ownership vouchers. Continuing with the example of the ownership voucher 700 discussed above, the end user may use the management device 212b to select the ownership voucher 700 in order to transmit the ownership transfer request that is received by the voucher management system 208 at decision block 504, and the method will then proceed to block 508 due to the end user being the “last owner” of the computing device 800.

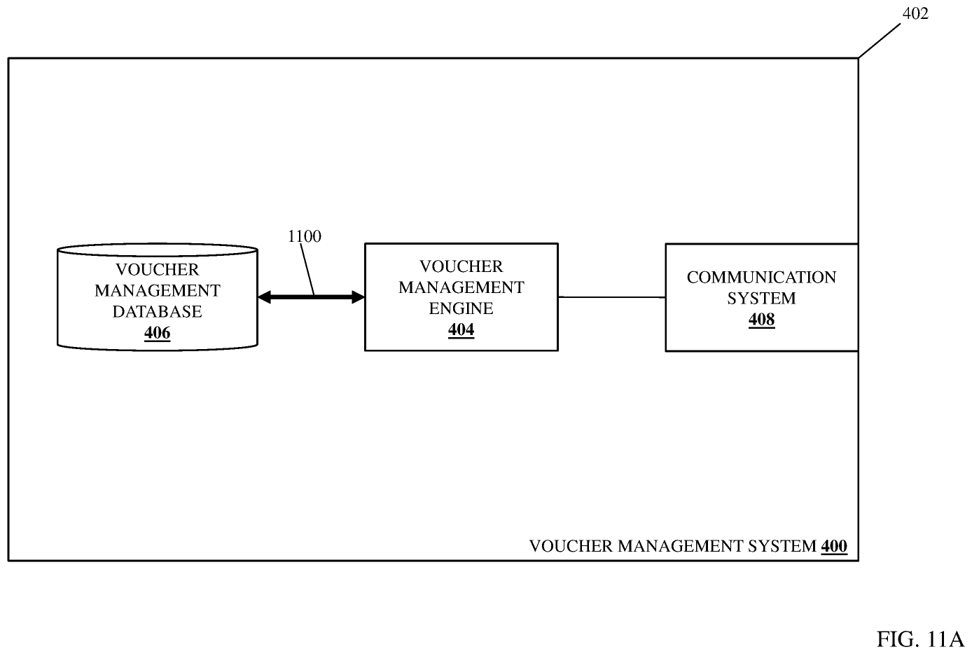

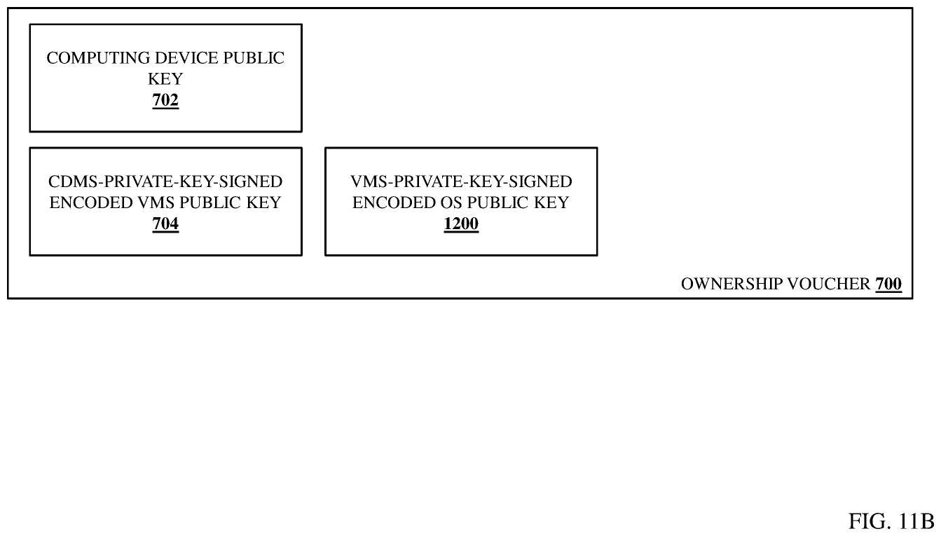

With reference to FIG. 11A, in an embodiment of block 508 and in response to receiving the ownership transfer request for the computing device 800, the voucher management engine 404 in the voucher management system 208/400 may perform last owner ownership transfer data generation operations 1100 that include using a VMS private key controlled by the voucher management system 208/400 to sign an encoded orchestrator system (OS) public key of the orchestrator system 212a to generate a VMS-private-key-signed encoded OS public key 1200.

In a specific example, the voucher management engine 404 may generate the VMS-private-key-signed encoded OS public key 1200 according to the FDO protocol by using the OS public key of the orchestrator system 212a that was provided via the management device 212b as discussed above, and performing a hashing operation on that OS public key, a GUID for the computing device 800, computing device information associated with the computing device 800 (e.g., serial number(s), MAC address(es), etc.), and/or other any other information that would be apparent to one of skill in the art in possession of the present disclosure in order to generate an encoded OS public key. The voucher management engine 404 may then sign that encoded OS public key with the VMS private key to provide the VMS-private-key-signed encoded OS public key 1200. However, while a specific example of the generation of last owner ownership transfer data provide by the VMS-private-key-signed encoded OS public key 1200 has been described, one of skill in the art in possession of the present disclosure will appreciate how the voucher management engine 404 may perform other operations according to the FDO protocol in order to transfer ownership of the computing device 800 to the orchestrator system 212a using the ownership voucher 700 while remaining within the scope of the present disclosure.

The method 500 then proceeds to block 510 where the voucher management system provides the last owner ownership transfer data in the ownership voucher to transfer ownership of the computing device to a last owner system. With reference to FIG. 11B, in an embodiment of block 510, the voucher management engine 404 in the voucher management system 208/400 may perform ownership transfer operations that include providing the VMS-private-key-signed encoded OS public key 1200 generated as discussed above in the ownership voucher 700. As will be appreciated by one of skill in the art in possession of the present disclosure, the CDMS-private-key-signed encoded VMS public key 704 provides for the transfer of the ownership of the computing device 800 from the computing device manufacturer system 202 to the voucher management system 208, allowing the VMS-private-key-signed encoded OS public key 1200 to provide for the transfer of the ownership of the computing device 800 from the voucher management system 208 to the orchestrator system 212a.

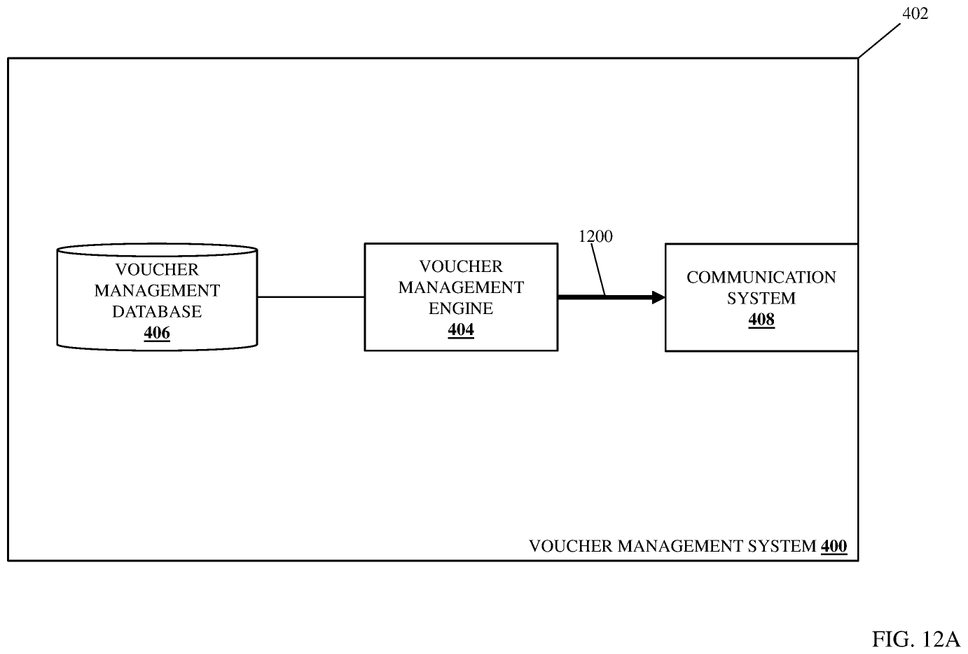

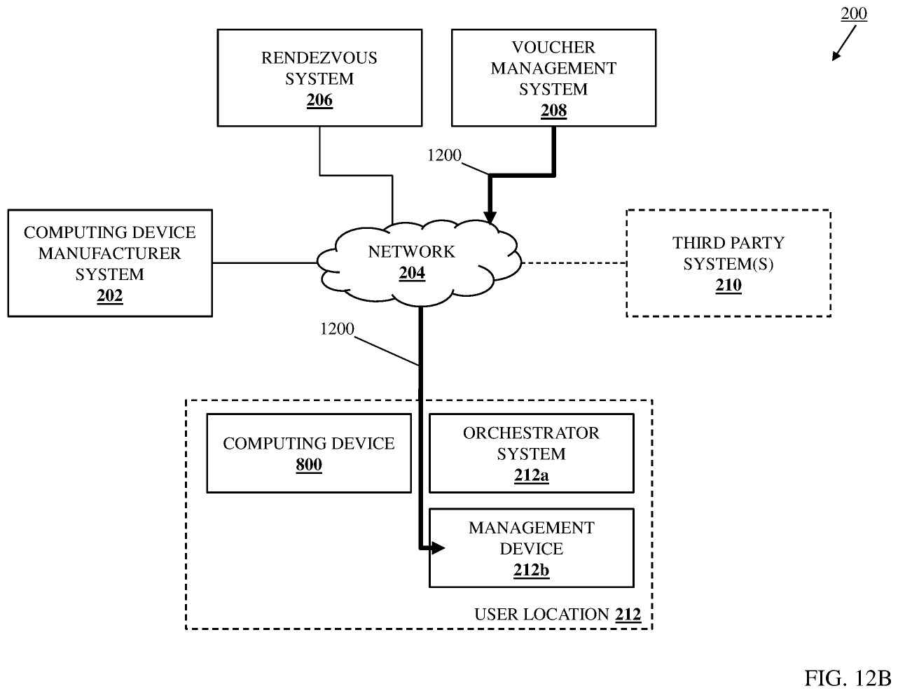

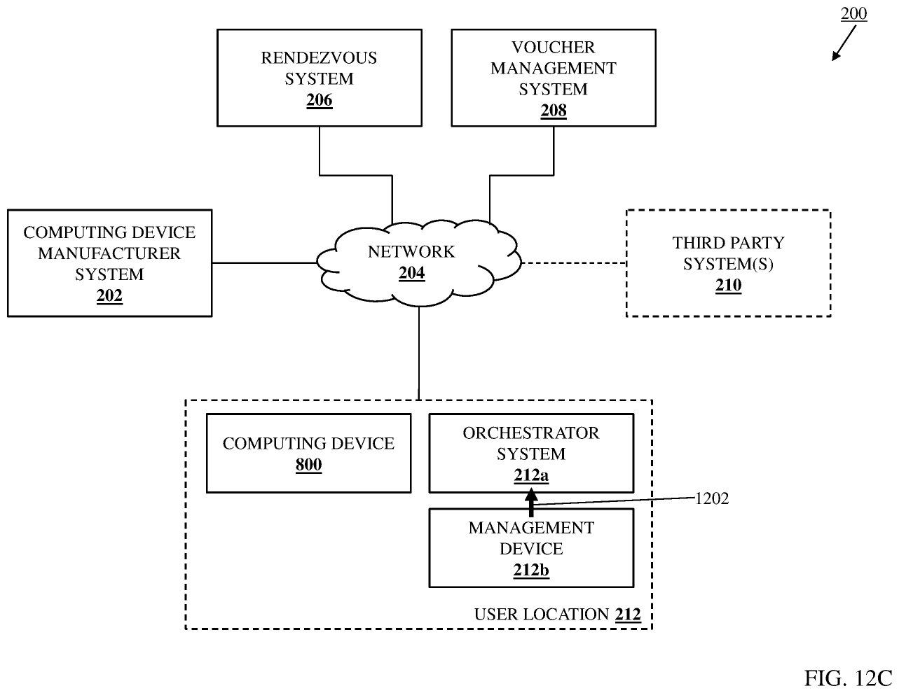

The method 500 then proceeds to block 512 where the voucher management system provides the ownership voucher to the last owner system. With reference to FIGS. 12A and 12B, in an embodiment of block 512, the voucher management engine 404 in the voucher management system 208/400 may perform ownership voucher transmission operations 1200 that include the voucher management engine 404 transmitting the ownership voucher 700 (i.e., with the CDMS-private-key-signed encoded VMS public key 704 and the VMS-private-key-signed encoded OS public key 1200) via its communication system 408 and through the network 204 to the management device 212b at the user location 212. For example, the ownership voucher transmission operations 1200 performed by the voucher management engine 404 may utilize a secure API and/or any other security techniques that would be apparent to one of skill in the art in possession of the present disclosure in order to transmit the ownership voucher 700 to the management device 212.

With reference to FIG. 12C, in response to receiving the ownership voucher 700 from the voucher management system 400, the management device 212b may perform ownership voucher transmission operations 1202 that include the management device 212b transmitting the ownership voucher 700 (i.e., with the CDMS-private-key-signed encoded VMS public key 704 and the VMS-private-key-signed encoded OS public key 1200) to the orchestrator system 212a at the user location 212. As such, at block 502, the orchestrator system 212a (a “last owner” in this example) at the user location 212 may receive the ownership voucher 700 from the voucher management system 208 (via the management device 212b) that transfers ownership of the computing device 800 to the orchestrator system 212a, and the orchestrator system 212a may perform ownership voucher storage operations that include storing the ownership voucher 700 in a database accessible at the user location 212.

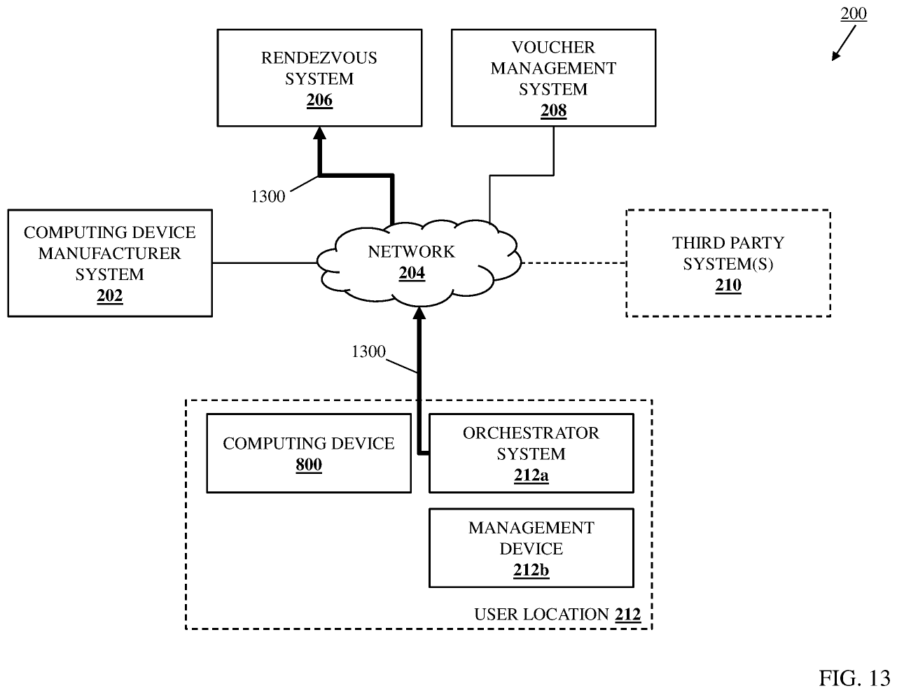

The method 500 then proceeds to block 514 where the last owner system uses the ownership voucher. With reference to FIG. 13, in an embodiment of block 514 and in response to receiving the ownership voucher 700, the orchestrator system 212a may perform rendezvous system registration operations 1300 that include registering with the rendezvous system 206 via the network 204. For example, the rendezvous system registration operations 1300 may include FDO-TOO protocol operations such as the orchestration system 212a performing a hashing operation on the ownership voucher 700 to generate an ownership voucher hash value, and providing that ownership voucher hash value to the rendezvous system 206, which one of skill in the art in possession of the present disclosure will recognize may operate to announce to the rendezvous system 206 that the orchestrator system 212a owns the computing device 800.

As discussed above, rendezvous system reachability information provided in the computing device 800 may provide for a “layered FDO rendezvous system onboarding process”. Continuing with the specific example above, the rendezvous system registration operations 1300 may include the orchestration system 212a accessing the rendezvous system reachability information provided in the computing device 800 to attempt to register with rendezvous systems based on prioritized pointers to different rendezvous systems provided by that rendezvous system reachability information. As such, the rendezvous system registration operations 1300 may include the orchestration system 212a first using the global rendezvous system reachability information (e.g., the “rendezvous.dell.com” pointer with the highest priority in the examples provided above) to attempt to register with the rendezvous system managed by the computing device manufacturer. In the event the orchestration system 212a is unable to register with the rendezvous system managed by the computing device manufacturer, the orchestration system 212a may then use the reseller local rendezvous system reachability information (e.g., the “rendezvous.var.com” pointer with the intermediate priority in the examples provided above, if present) to attempt to register with the rendezvous system managed by the third party/reseller. In the event the orchestration system 212a is unable to register with the rendezvous system managed by the third party/reseller, the orchestration system 212a may then use the end user local rendezvous system reachability information (e.g., the “rendezvous.enduser.com” pointer with the lowest priority in the examples provided above, if present) to attempt to register with the rendezvous system managed by the end user.

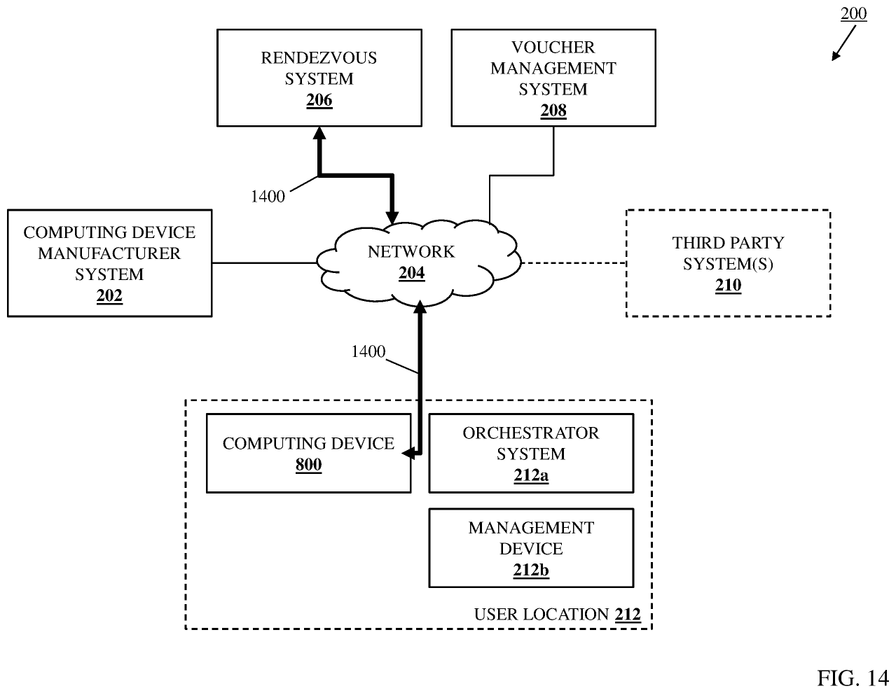

With reference to FIG. 14, in an embodiment of block 514 and in response to being powered on, the computing device 800 may perform owner identification operations 1400 that include communicating with the rendezvous system 206 via the network 204 to identify the owner of the computing device 800. For example, the owner identification operations 1400 may include FDO-TO1 protocol operations such as the rendezvous system 206 using the communications with the computing device 800 to identify the ownership voucher hash value received from the orchestration system 212a, and then redirecting the computing device 800 to the orchestrator system 212a.

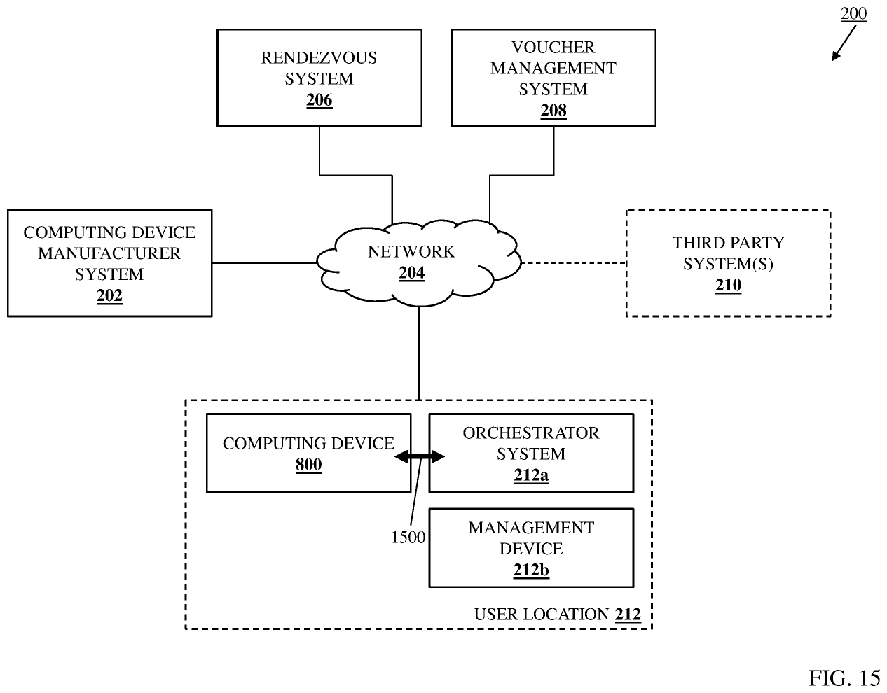

With reference to FIG. 15, in an embodiment of block 514 and in response to being redirected to the orchestrator system 212a by the rendezvous system 206, the computing device 800 may perform authentication operations 1500 with the orchestrator system 212a. For example, the authentication operations 1500 may include FDO-TO2 protocol operations such as the orchestrator system 212a signing a nonce with its OS private key to generate an OS-private-key-signed nonce, transmitting the OS-private-key-signed nonce along with the ownership voucher 700 to the computing device 800, and the computing device 800 verifying the OS-private-key-signed nonce using the OS public key of the orchestrator system 212a, which one of skill in the art in possession of the present disclosure will recognize proves that orchestrator system 212a has control of the OS private key.

Similarly, the computing device 800 may sign a nonce with its computing device private key to generate a computing-device-private-key-signed nonce, transmit the computing-device-private-key-signed nonce to the orchestrator system 212a, with the orchestrator system 212a verifying the computing-device-private-key-signed nonce using the computing device public key of the computing device, which one of skill in the art in possession of the present disclosure will recognize proves that computing device 800 has control of the computing device private key. The computing device 800 may then retrieve the computing device manufacturer public key 702 from the ownership voucher 700, verify the computing device manufacturer public key 702, and then verify the CDMS-private-key-signed encoded VMS public key 704 and the VMS-private-key-signed encoded OS public key 1200 in the ownership voucher 700, which one of skill in the art in possession of the present disclosure will recognize verifies the chain of ownership secured by the private key signatures to authenticate the orchestrator system 212a as the owner of the computing device 800.

As such, one of skill in the art in possession of the present disclosure will recognize that the computing device 800 may be utilized at the user location 212 following block 514. Thus, the “direct” computing-device-manufacturer-to-end-user scenario described above allows ownership of the computing device 800 to be transferred by the computing device manufacturer system 202 to the voucher management system 208, and then directly from the voucher management system 208 to the end user that ordered the computing device 800 without having any intermediate owners in between. However, as discussed below, an “indirect” computing-device-manufacturer-to-end-user scenario may be enabled in which ownership of the computing device 800 is transferred by the computing device manufacturer system 202 to the voucher management system 208, and then from the voucher management system 208 to one or more third parties (“intermediate owner(s)” in that example) before being transferred to the end user that ordered the computing device 800.

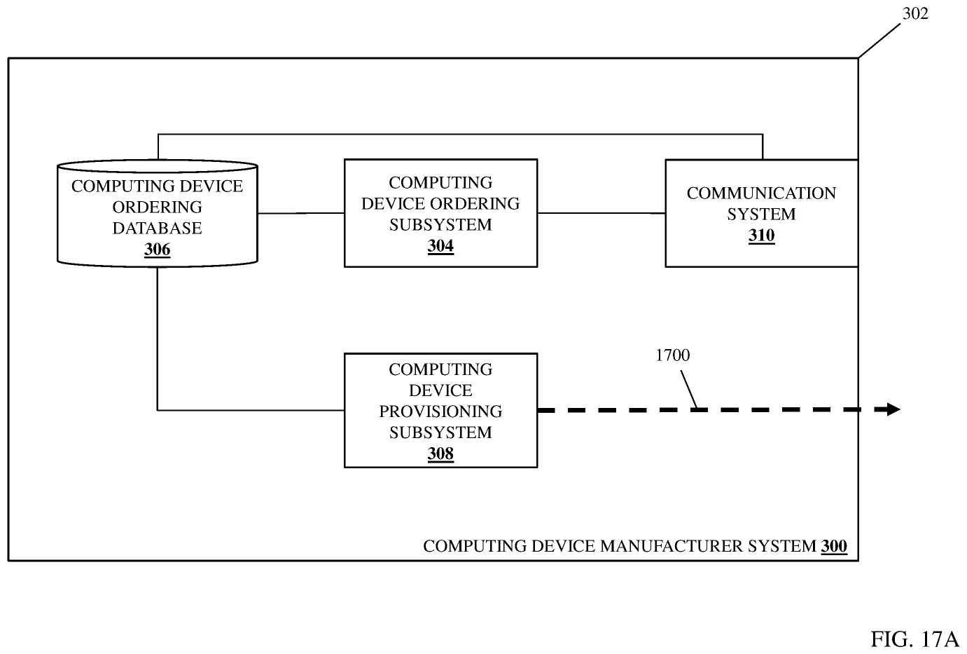

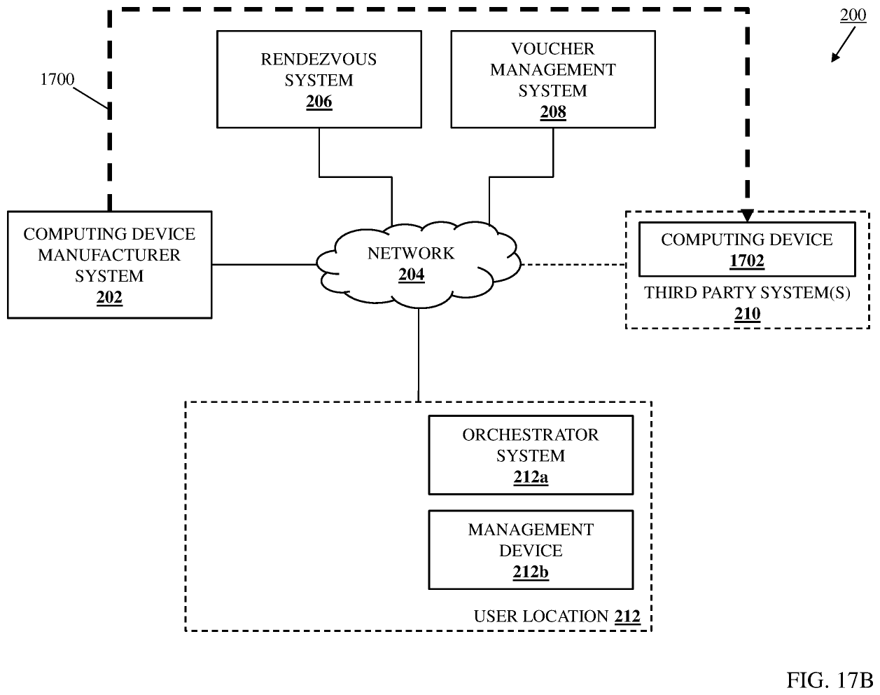

In such an “indirect” computing-device-manufacturer-to-end-user scenario, block 502 may be modified such that, instead of the end user at the user location 212 ordering the computing device from the computing device manufacturer system 202, a third party (e.g., a reseller) may order the computing device from the computing device and system 202 in a manner similar to that described above between the end user and the computing device manufacturer system 202, with the end user at the user location 212 then ordering the computing device from the third party in a manner similar to that described above between the end user and the computing device manufacturer system 202. As such, with reference to FIGS. 17A and 17B, subsequent to the completion of the manufacturing of the computing device ordered by the third party, the computing device manufacturer system 300 may perform computing device provisioning operations 1700 that include the computing device provisioning subsystem 308 in the computing device manufacturer system 202/300 providing a computing device 1702 (which one of skill in the art in possession of the present disclosure will recognize is the computing device that was ordered by the third party as discussed above) to a location associated with the third party system 210. As will be appreciated by one of skill in the art in possession of the present disclosure, the computing device provisioning operations 1700 may be performed by shipping the computing device 1702 that was ordered by the third party and manufactured by the computing device manufacturer system 202/300 to the location associated with the third party system 210 for performing value-adds to the computing device 1702 and/or otherwise providing for reselling to the end user. As such, following block 502, the computing device 1700 may be located at the location associated with the third-party system 210, and the ownership voucher 700 may be stored at the voucher management system 208 and may indicate that the voucher management system 208 owns the computing device 800.

Similarly as discussed above, in an embodiment of decision blocks 504 and 506, the third party that received the computing device 1702 at the location associated with third party system 210 may utilize the third party system 210 to perform voucher management system access operations that include accessing the voucher management system 208 via the network 204 in a manner similar to that discussed above by the end user. In response to authenticating the third party, the voucher management engine 404 in the voucher management system 208 may retrieve any computing device ordering information about computing device(s) ordered by the third party that was authenticated, use the computing device ordering information about computing device(s) ordered by the third party that was authenticated to identify any ownership vouchers in the voucher management database 406, and provide any of the ownership vouchers identified for the third party for display on the third party system 210. As such, one of skill in the art in possession of the present disclosure will recognize that the voucher management system 208 may provide a single, centralized location/source for third party to review any ownership vouchers that define the ownership of any computing devices ordered by the third party. As will be appreciated by one of skill in the art in possession of the present disclosure, such a single, centralized location/source for ownership vouchers review may be particularly beneficial to third parties that order hundreds, and even thousands, of computing devices from the computing device manufacturer.

Similarly as described above, an embodiment of decision blocks 504 and 506 may include the third party using the third party system 210 to select one or more ownership vouchers that were provided for display by the voucher management system 208 on the third party system 210 in order to transmit the ownership transfer request for those ownership vouchers. Continuing with the example of the ownership voucher 700 discussed above, the third party may use the third-party system 210 to select the ownership voucher 700 in order to transmit the ownership transfer request that is received by the voucher management system 208 at decision block 504, and the method will then proceed to block 508 due to the third party being an “intermediate owner” of the computing device 1702.

Thus, returning to decision block 506, if the ownership transfer is to an intermediate owner, the method 500 proceeds to block 516 where the voucher management system automatically generates an intermediate owner public/private key pair. In an embodiment, at block 516, the voucher management engine 404 in the voucher management system 208/400 may generate a third-party public/private key pair (e.g., prior to the transfer of ownership of the computing device to that third party, in response a request to transfer ownership of the computing device to that third party, etc.) for any third party (an “intermediate owner” in this example) that takes possession of a computing device for eventual provisioning to an end user, and may store that third-party public/private key pair in its voucher management database 408. However, while the voucher management system 208 is described as generating the third-party public/private key pair described herein, one of skill in the art in possession of the present disclosure will appreciate how a third party may generate its own third-party public/private key pair (and provide its third-party public key to the voucher management system 208 for use as discussed below) in other embodiments while remaining within the scope of the present disclosure as well.

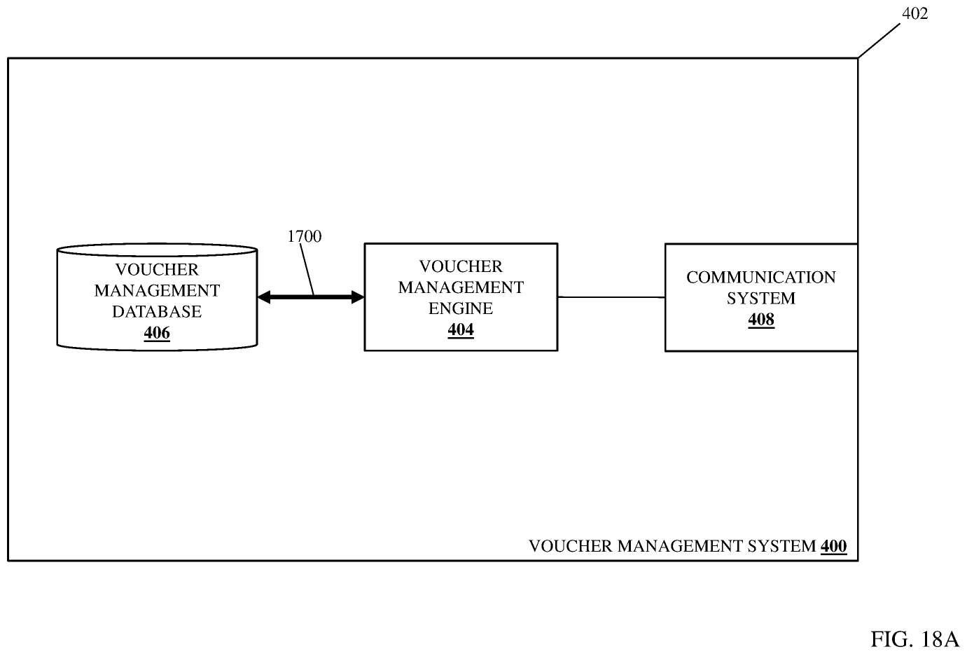

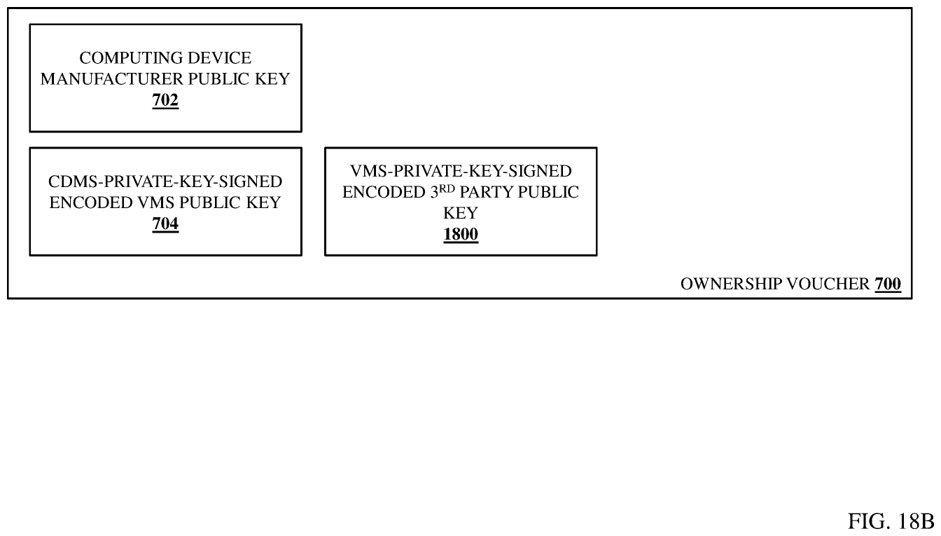

The method 500 then proceeds to block 518 where the voucher management system automatically generates intermediate owner ownership transfer data. With reference to FIG. 18A, in an embodiment of block 518 and in response to receiving the ownership transfer request for the computing device 1702, the voucher management engine 404 in the voucher management system 208/400 may perform intermediate owner ownership transfer data generation operations 1700 that include using a VMS private key controlled by the voucher management system 208/400 to sign an encoded third party public key of the third party system 210 to generate a VMS-private-key-signed encoded third party public key 1800.

In a specific example, the voucher management engine 404 may generate the VMS-private-key-signed encoded third party public key 1800 according to the FDO protocol by using the third party public key of the third party system 210 that was generated by the voucher management system 208/400 (or received from the third party system 210) as discussed above, and performing a hashing operation on that third party public key, a GUID for the computing device 1702, computing device information associated with the computing device 1702 (e.g., serial number(s), MAC address(es), etc.), and/or other any other information that would be apparent to one of skill in the art in possession of the present disclosure in order to generate an encoded third party public key. The voucher management engine 404 may then sign that encoded third party public key with the VMS private key to provide the VMS-private-key-signed encoded third-party public key 1800. However, while a specific example of the generation of intermediate owner ownership transfer data provided by the VMS-private-key-signed encoded third party public key 1800 has been described, one of skill in the art in possession of the present disclosure will appreciate how the voucher management engine 404 may perform other operations according to the FDO protocol in order to transfer ownership of the computing device 800 to a third party system 210 using the ownership voucher 700 while remaining within the scope of the present disclosure.

The method 500 then proceeds to block 520 where the voucher management system provides the intermediate owner ownership transfer data in the ownership voucher to transfer ownership of the computing device to an intermediate owner system. With reference to FIG. 18B, in an embodiment of block 520, the voucher management engine 404 in the voucher management system 208/400 may perform ownership transfer operations that include providing the VMS-private-key-signed encoded third-party public key 1800 generated as discussed above in the ownership voucher 700. As will be appreciated by one of skill in the art in possession of the present disclosure, the CDMS-private-key-signed encoded VMS public key 704 provides for the transfer of the ownership of the computing device 800 from the computing device manufacturer system 202 to the voucher management system 208, allowing the VMS-private-key-signed encoded third party public key 1800 to provide for the transfer of the ownership of the computing device 800 from the voucher management system 208 to a third party system 210. However, contrary to the “direct” computing-device-manufacturer-to-end-user scenario in which the ownership voucher 700 is provided to the orchestrator system 212a at the user location 212, in the “indirect” computing-device-manufacturer-to-end-user scenario the ownership voucher 700 may be stored in the voucher management database 408 of the voucher management system 208/400, although situations in which the ownership voucher 700 (or at least a copy of the ownership voucher 700) are provided to the third party system 210 are envisioned as falling within the scope of the present disclosure as well.

The method 500 then proceeds to decision block 522 where it is determined whether an ownership transfer request has been received. In an embodiment, at decision block 522 and following the transfer of ownership of the computing device 1702 to an intermediate owner (i.e., one of the third parties discussed above), the voucher management engine 404 in the voucher management system 208/400 may monitor for an ownership transfer request similarly as discussed above. If, at decision block 522, it is determined that an ownership transfer request has not been received, the method 500 returns to decision block 522. As such, the method 500 may loop as long as the voucher management system has not received an ownership transfer request. If, at decision block 522, it is determined that an ownership transfer request has been received, the method 500 proceeds to decision block 524 where the method 500 proceeds similarly as described above depending on whether the ownership transfer is to a last owner or an intermediate owner.

If, at decision block 524, it is determined that the ownership transfer is to an intermediate owner, the method 500 returns to block 516. As such, the method 500 may loop such that the voucher management system 208 performs blocks 516, 518, and 520 to transfer ownership of the computing device 1702 to any further third parties/intermediate owners using the ownership voucher 700 similarly as described above. For example, to transfer ownership from the “1^{st} third party” discussed above to a “2^{nd} third party”, the voucher management system 208 may provide a 2^{nd}-third-party-private-key-signed encoded 1^{st} third party public key in the ownership voucher 700 similarly as described above, with the CDMS-private-key-signed encoded VMS public key 704 providing for the transfer of the ownership of the computing device 800 from the computing device manufacturer system 202 to the voucher management system 208, and the VMS-private-key-signed encoded “1st” third party public key 1800 providing for the transfer of the ownership of the computing device 800 from the voucher management system 208 to a 1^{st} third party system 210, allowing the 2^{nd}-third-party-private-key-signed encoded 1^{st} third party public key to provide for the transfer of the ownership of the computing device 800 from the 1^{st} third party system 210 to a 2^{nd} third party system 210. One of skill in the art in possession of the present disclosure will appreciate how this process may be repeated for any further intermediate owners prior to the last owner.

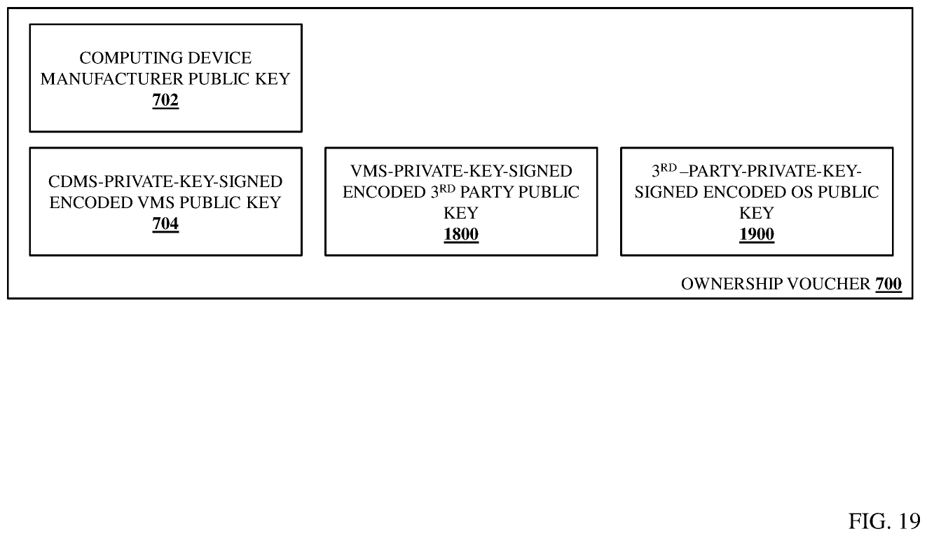

If, at decision block 524, it is determined that the ownership transfer is to a last owner, the method 500 proceeds to blocks 508, 510, 512, and 514 as discussed above. With reference to FIG. 19, continuing with the specific example above that includes one third party between the computing device manufacturer and the end user, one of skill in the art in possession of the present disclosure will appreciate how the performance of blocks 508, 510, 512, and 514 following the performance of blocks 516, 518, and 520 as discussed above may result in the voucher management system 208/400 providing a third-party-private-key-signed encoded OS public key 1900 in the ownership voucher 700 similarly as described above, with the CDMS-private-key-signed encoded VMS public key 704 providing for the transfer of the ownership of the computing device 800 from the computing device manufacturer system 202 to the voucher management system 208, and the VMS-private-key-signed encoded third party public key 1800 providing for the transfer of the ownership of the computing device 800 from the voucher management system 208 to the third party system 210, allowing the third-party-private-key-signed encoded OS public key 1900 to provide for the transfer of the ownership of the computing device 800 from the third party system 210 to the orchestrator system 212b.

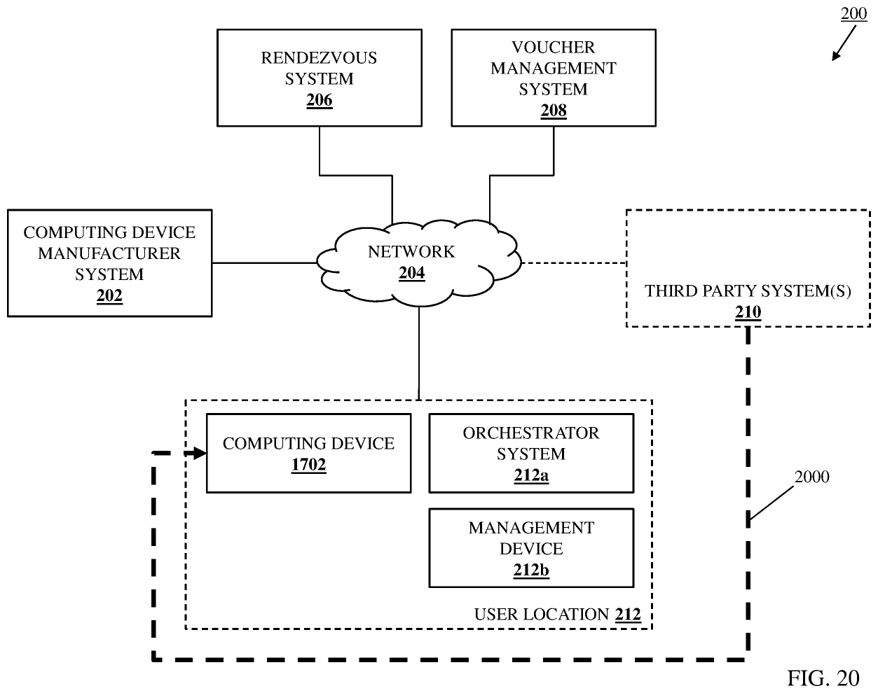

Furthermore, with reference to FIG. 20, the third-party system 210 may perform computing device provisioning operations 200 that include providing the computing device 1702 (which one of skill in the art in possession of the present disclosure will recognize is the computing device that was ordered by the end user from the third party in a manner similar to that described above between the end user and the computing device manufacturer) to the user location 212. As will be appreciated by one of skill in the art in possession of the present disclosure, the computing device provisioning operations 2000 may be performed by shipping the computing device 1702 that was ordered by the end user from the third party (e.g., a reseller buying the computing device 1702 that was manufactured by the computing device manufacturer system 202/300) to the user location 212. As such, one of skill in the art in possession of the present disclosure will recognize that the computing device 1702 may be utilized at the user location 212 following block 514.

As will be appreciated by one of skill in the art in possession of the present disclosure, in some situations it may be desirable to change the ownership of the computing device 800/1702 to another orchestrator system at the user location 212 or in another user location. In such situations, the computing device 800/1702 may be reset to a factory state (e.g., using a reset command provided by the orchestrator system 212a, via the use of a reset button the computing device 800/1702, or using other reset techniques known in the art). The end user may then access the voucher management system 208 again as described with reference to FIG. 10A and perform the subsequent process described above to onboard the computing device to a different orchestrator system, as the voucher management system 208 will store or otherwise maintain the ownership voucher 700 received from the computing device manufacturer, while the orchestrator system 212a will store or otherwise maintain the ownership voucher 700 that transferred ownership of the computing device 800/1702 to the orchestrator system 212a.

Thus, systems and methods have been described that provide an ownership voucher management system that manages ownership vouchers utilized in the FDO protocol in order to facilitate the transfer of ownership of a computing device from a first owner to a last owner, and in some cases between one or more intermediate owners between the first owner and the last owner. For example, the FDO protocol ownership voucher management system of the present disclosure may be provided in a networked system including a first owner system and a second owner system coupled to a voucher management system. The voucher management system receives, from the first owner system, an ownership voucher having first ownership transfer data including a voucher management system public key that has been signed by a first owner system private key in order to transfer ownership of a computing device from the first owner system to the voucher management system. The voucher management system determines that the ownership of the computing device should be transferred to the second owner system and, in response, automatically generates second ownership transfer data by signing a second owner system public key with a voucher management system private key, and provides the second ownership transfer data in the ownership voucher in order to transfer ownership of the computing device from the voucher management system to the second owner system.

As such, ownership voucher transfer from a computing device manufacturer to an end user is simplified without breaking the FDO protocol (via the use of FDO-TO protocols at each transfer point) and without requiring end users/last owners or third parties/intermediate owners to provide, operate, and maintain FDO protocol support systems. Thus, a cryptographically secure, “zero-touch” experience is provided for ownership voucher transfer from a computing device manufacturer to an orchestrator system, thus allowing “zero-touch” securing onboarding of computing devices to the orchestrator system. As discussed above, the systems and methods of the present disclosure enable migration of computing devices between orchestrator systems, while also enabling computing device ordering either directly from the computing device manufacturer or through resellers while still maintain secure FDO protocol ownership transfers. As will be appreciated by one of skill in the art in possession of the present disclosure, the systems and methods of the present disclosure may be combined with zero-touch automation techniques to enable relatively large-scale secure FDO protocol onboarding of hundreds (or even thousands) of computing devices simultaneously.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Fast Identity Online (FIDO) Device Onboarding (FDO) protocol computing device ordering/manufacturing system, comprising:
a voucher management system; and
a computing device manufacturer system that is coupled to the voucher management system and that includes:
a computing device ordering subsystem that is configured to:
identify, as part of an ordering process for a computing device being ordered by a subsequent owner, rendezvous system reachability information for at least one rendezvous system;
a computing device provisioning subsystem that is coupled to the computing device ordering subsystem and that is configured to:
receive, from the computing device ordering subsystem, the rendezvous system reachability information;
provide the rendezvous system reachability information in the computing device prior to the computing device being transferred to the subsequent owner;
retrieve, from the voucher management system, a voucher management system public key;
sign, using a computing device manufacturer private key, the voucher management system public key to generate first ownership transfer data;
provide the first ownership transfer data in an ownership voucher in order to transfer ownership of the computing device from the computing device manufacturer system to the voucher management system; and
provide the ownership voucher to the voucher management system.

2. The system of claim 1, wherein the identifying the rendezvous system reachability information for the at least one rendezvous system includes receiving the rendezvous system reachability information from the subsequent owner during the ordering process for the computing device.

3. The system of claim 1, wherein the identifying the rendezvous system reachability information for the at least one rendezvous system includes retrieving the rendezvous system reachability information from the computing device manufacturing system.

4. The system of claim 1, wherein the rendezvous system reachability information is for a plurality of rendezvous systems, and wherein the providing the rendezvous system reachability information in the computing device includes prioritizing the rendezvous system reachability information for each of the plurality of rendezvous systems in order to configure the computing device to contact the plurality of rendezvous systems based on the priority of their rendezvous system reachability information.

5. The system of claim 1, wherein the computing device ordering subsystem is configured to:
generate, as part of the ordering process for the computing device being ordered by the subsequent owner, computing device ordering information; and
associate a subsequent owner identifier for the subsequent owner with the computing device ordering information in a computing device ordering database.

6. The system of claim 5, wherein the voucher management system is configured to:
map the ownership voucher to the subsequent owner identifier associated with the computing device ordering information in the computing device ordering database.

7. The system of claim 1, wherein the computing device provisioning subsystem includes:
a private key signing module that is configured to sign the voucher management system public key using the computing device manufacturer private key to generate the first ownership transfer data; and
an ownership voucher generation module that is configured to:
retrieve the voucher management system public key from the voucher management system;
provide, to the private key signing module using a secure Application Programming Interface (API), the voucher management system public key;
receive, from the private key signing module using the secure API, the first ownership transfer data;
provide the first ownership transfer data in the ownership voucher.

8. An Information Handling System (IHS), comprising:
a processing system; and
a memory system that is coupled to the processing system and that includes instructions that, when executed by the processing system, cause the processing system to provide a computing device manufacturing engine that is configured to:
identify, as part of an ordering process for a computing device being ordered by a subsequent owner, rendezvous system reachability information for at least one rendezvous system;
provide the rendezvous system reachability information in the computing device prior to the computing device being transferred to the subsequent owner;
retrieve, from a voucher management system, a voucher management system public key;
sign, using a computing device manufacturer private key, the voucher management system public key to generate first ownership transfer data;
provide the first ownership transfer data in an ownership voucher in order to transfer ownership of the computing device from the computing device manufacturer system to the voucher management system; and
provide the ownership voucher to the voucher management system.

9. The IHS of claim 8, wherein the identifying the rendezvous system reachability information for the at least one rendezvous system includes receiving the rendezvous system reachability information from the subsequent owner during the ordering process for the computing device.

10. The IHS of claim 8, wherein the identifying the rendezvous system reachability information for the at least one rendezvous system includes retrieving the rendezvous system reachability information from a computing device manufacturing system.

11. The IHS of claim 8, wherein the rendezvous system reachability information is for a plurality of rendezvous systems, and wherein the providing the rendezvous system reachability information in the computing device includes prioritizing the rendezvous system reachability information for each of the plurality of rendezvous systems in order to configure the computing device to contact the plurality of rendezvous systems based on the priority of their rendezvous system reachability information.

12. The IHS of claim 8, wherein the computing device manufacturing engine is configured to:
generate, as part of the ordering process for the computing device being ordered by the subsequent owner, computing device ordering information;
associate a subsequent owner identifier for the subsequent owner with the computing device ordering information in a computing device ordering database.

13. The IHS of claim 8, wherein the computing device manufacturing engine includes:
a private key signing module that is configured to sign the voucher management system public key using the computing device manufacturer private key to generate the first ownership transfer data; and
an ownership voucher generation module that is configured to:
retrieve the voucher management system public key from the voucher management system;
provide, to the private key signing module using a secure Application Programming Interface (API), the voucher management system public key;
receive, from the private key signing module using the secure API, the first ownership transfer data;
provide the first ownership transfer data in the ownership voucher.

14. A method for ordering/manufacturing a computing device, comprising:
identifying, by a computing device manufacturing system as part of an ordering process for a computing device being ordered by a subsequent owner, rendezvous system reachability information for at least one rendezvous system;
providing, by the computing device manufacturing system, the rendezvous system reachability information in the computing device prior to the computing device being transferred to the subsequent owner;
retrieving, by the computing device manufacturing system from a voucher management system, a voucher management system public key;
signing, by the computing device manufacturing system using a computing device manufacturer private key, the voucher management system public key to generate first ownership transfer data;
providing, by the computing device manufacturing system, the first ownership transfer data in an ownership voucher in order to transfer ownership of the computing device from the computing device manufacturer system to the voucher management system; and
providing, by the computing device manufacturing system, the ownership voucher to the voucher management system.

15. The method of claim 14, wherein the identifying the rendezvous system reachability information for the at least one rendezvous system includes receiving the rendezvous system reachability information from the subsequent owner during the ordering process for the computing device.

16. The method of claim 14, wherein the identifying the rendezvous system reachability information for the at least one rendezvous system includes retrieving the rendezvous system reachability information from the computing device manufacturing system.

17. The method of claim 14, wherein the rendezvous system reachability information is for a plurality of rendezvous systems, and wherein the providing the rendezvous system reachability information in the computing device includes prioritizing the rendezvous system reachability information for each of the plurality of rendezvous systems in order to configure the computing device to contact the plurality of rendezvous systems based on the priority of their rendezvous system reachability information.

18. The method of claim 14, further comprising:
generating, by the computing device manufacturing system as part of the ordering process for the computing device being ordered by the subsequent owner, computing device ordering information; and
associating, by the computing device manufacturing system, a subsequent owner identifier for the subsequent owner with the computing device ordering information in a computing device ordering database.

19. The method of claim 18, further comprising:
mapping, by the voucher management system, the ownership voucher to the subsequent owner identifier associated with the computing device ordering information in the computing device ordering database.

20. The method of claim 19, further comprising:
retrieving, by an ownership voucher generation module in the computing device manufacturing system, the voucher management system public key from the voucher management system;
providing, by the ownership voucher generation module to a private key signing module in the computing device manufacturing system using a secure Application Programming Interface (API), the voucher management system public key;
signing, by the private key signing module, the voucher management system public key using the computing device manufacturer private key to generate the first ownership transfer data;
receiving, by the ownership voucher generation module from the private key signing module using the secure API, the first ownership transfer data; and
providing, by the ownership voucher generation module, the first ownership transfer data in the ownership voucher.
